(19) United States
(12) Patent Application Publication
(10) Pub. No.: US 2025/0192696 A1
(43) Pub. Date: Jun. 12, 2025

(54) THREE-PHASE INVERTER

(71) Applicant: PETRÓLEO BRASILEIRO S.A. - PETROBRAS, Rio de Janeiro (BR)

(72) Inventor: EMMANUEL CORDEIRO DIAS, Macaé (BR)

(73) Assignee: PETRÓLEO BRASILEIRO S.A. - PETROBRAS, Rio de Janeiro (BR)

(21) Appl. No.: 18/972,298

(22) Filed: Dec. 6, 2024

(30) Foreign Application Priority Data
Dec. 6, 2023 (BR) 1020230256066

(51) Int. Cl. H02M 7/5387; H02M 1/00; H02M 1/12

(52) U.S. Cl. CPC H02M 7/53875; H02M 1/0058; H02M 1/126

(57) ABSTRACT

The present invention relates to an electronic arrangement of a three-phase frequency inverter with sinusoidal output and variable frequency that output voltage with low total harmonic distortion, absence of overshoot in the output voltage for any load variation and thus with its precursor, and does not require the use of passive output filters. Put another way, the innovation involves topology providing sinusoidal output voltage, eliminating the need for passive output filters and mitigating problems such as burning of the motor related to overvoltages resulting from conventional PWM switching, premature bearing failures, helps reduce excessive vibrations and temperature increases caused by harmonics, has the ability to supply unbalanced loads, reduces irradiated and conducted noise-EMI, mainly in the feeders (cables) that feed the motors, among other benefits.

### CROSS REFERENCE TO RELATED APPLICATION

The present application claims the benefit of and priority to Brazilian Patent Application No. BR 1020230256066, filed Dec. 6, 2023, the entire contents of which are fully incorporated herein by reference.

### FIELD

The present invention falls within the technical field of several industrial applications such as automation, dynamic equipment, vessels, platforms, probes (production facilities), oil production processes and renewable energy. All global industries in various fields and types make use of inverters in their plants, whether textile, mining, automotive, transformation, steel, paper, petrochemical, offset printing, sanitation plants and many others. Specifically, the present invention relates to technologies involving the use of three-phase inverters. Versatility of these devices makes them essential in a variety of industrial fields, where precise speed control and energy efficiency are essential requirements.

### BACKGROUND

The use of non-sinusoidal three-phase inverters in industrial processes introduces a significant layer of complexity into electrical systems. These inverters with their PWM pulse voltage output offer advantages in terms of control and efficiency, but they also bring substantial challenges that require careful consideration. One of the main obstacles lies in the possibility of overvoltage that can result from the switching process of the semiconductor switches present in the inverters. These overvoltages pose a direct threat to engines used in industrial processes, and can result in failures and significant damage. The need to carry out detailed studies on motor isolation supportability becomes crucial to avoid unnecessary losses. Furthermore, the proposed solutions to address such challenges add up an additional layer of complexity. Changing cables, changing the type of motor connection or even replacing them with more robust models are viable options, but each one carries implications in terms of costs and logistics.

The processes, plants or equipment have motors that are mostly powered using three-phase inverters with non-sinusoidal PWM voltage output. The use of these types of inverters can sometimes result in motors burning out due to overvoltages originating from the switching process of semiconductor switches. Studies on the motor isolation supportability, changing of cables or changing the type of connection, or even changing the motor for another that can withstand the overvoltage caused by the inverter are required. There are also inverters with non-sinusoidal PWM output that have a passive filter at their output, which tries to minimize the effects of the PWM output on the power supply to the loads, filtering out unwanted harmonics and delivering a voltage close to sinusoidal. In other instances, transformers are used for this purpose, among other possible solutions. However, using these solutions brings some drawbacks, such as increased cost, weight, difficulty in creating parallelism between inverters in instances where this type of connection is necessary, resonances with the electrical system they are feeding, being difficult to adjust and tune in some cases.

In particular, the main purpose of a frequency inverter is to transform direct voltage into alternating voltage. Therefore, its use is essential in applications where it is imperative to supply uninterrupted alternating current loads from a battery bank or other sources of direct voltage. Another essential use for a three-phase frequency inverter is its application for driving and adjusting the speed of three-phase induction motors (TIM), as it provides for variation in the voltage and frequency module, making it possible to control the speed and torque thereof, replacing direct current motors in various applications. Furthermore, its use brings additional gains such as reduced starting current, reduced energy consumption, smooth motor activation and starting, among others.

Its application in the control of compressor motors, pumps, electric cars, in solar and wind power plants, among others, is widely carried out today, and is therefore of vital importance for the development of modern society. Therefore, industries all over the world use three-phase inverters in their plants, making them an indispensable and vital piece of equipment for the large global production of goods and products.

In this context, there is a need to develop a frequency inverter that solves the following problems: (i) burning of motors caused by overvoltages due to the use of inverters with non-sinusoidal PWM voltage output; (ii) burning of inverters placed in parallel to supply high-power motors. Parallelism between inverters due to the presence of passive output filters can lead to failure and burning of drivers, making it impossible to power the motor; (iii) harmonic distortions that can cause stress on the cable isolation system and eddy currents through the motor bearings when using inverters with non-sinusoidal voltage output; (iv) torques that act in the opposite direction to the fundamental, increased temperature, audible noise and reduced motor life due to non-sinusoidal power supply; (v) high electromagnetic interference due to the dv/dt of the inverter's non-sinusoidal PWM output voltage.

In view of this and in order to solve the technical problems described above, the three-phase inverter of the present invention provides advantages such as: (i) sinusoidal output voltage, which is ideal for powering electric motors and electrical loads in general; (ii) it does not have passive output filters; (iii) it allows the connection of ECD inverters in parallel; (iv) absence of overshoot in the output voltage for any charge variation; (v) low output harmonic distortion (THD).

Furthermore, it is observed that the use of frequency inverters is essential in any industry in modern society. Any motor driving that requires speed and torque management uses a frequency inverter for this purpose in most of these applications. Therefore, not only in production plants, but throughout the industry, the frequency inverter is a fundamental piece of equipment. This equipment is essential for controlling and converting the energy generated in different systems, and is therefore of utmost importance in the context of social development. New converter topologies, such as the one proposed in the present invention, can bring advantages covering the entire range of global industries, such as oil, automotive, transformation, renewable energy, among others.

The use of frequency inverters in their entirety is in line with the improvement of motor control processes and industrial plants. The higher the level of quality of the voltage delivered by this equipment, the better the results of control of the process, system or driven machine, reducing all the aforementioned problems and hence increasing safety as a whole.

Furthermore, the use of three-phase induction motors as well as the use of electric generators are recognized for their high efficiency and for being part of a green electricity generation matrix, when they are driven by hydroelectric sources and other sources of low CO₂ emission. Unlike combustion engines, gas turbines and the use of coal, the use of electric motors is in line with new “green solutions”, as they do not emit pollutants into the atmosphere when used. Electric cars are an example of such new vision of applying electricity. Another example refers to its application in solar systems, where it is also necessary to use an inverter in the process of converting and transmitting the generated electrical energy. Therefore, use of the inverter is essential for reducing kg CO₂/kWh, being an essential equipment in this process, benefiting the global energy transition to a low-carbon green economy.

In other words, the three-phase inverter of the present invention having sinusoidal output, no filter and no overshoot for any load variation enables to power motors and loads over long distances, does not cause the winding to burn due to overvoltages produced by conventional PWM signals, reduces stress on cable insulation, eliminates the problem of resonances caused by filters or inverters with non-sinusoidal PWM output, enables the use of inverters in parallel, among other multiple possibilities and improvements.

### STATE OF THE ART

Several inverters have been disclosed in the state of the art, however, they exhibit differences when compared to the three-phase inverter of the present invention.

Patent document EP0729220A1, for example, refers to a voltage control capable of acting on a two-way electric current flowing in an inductive load, such control being carried out using static elements from a source that provides a permanent one-way electric voltage. In the document description, a method that performs such control is designated a method of controlling the electric current. The device that implements it is conventionally designated as an inverter. An inverter of this kind includes switches that are usually semiconductors and that allow a discontinuous voltage to be applied to the load. Where cycles are performed in a switching mode designated as “zero voltage”, belonging to a category designated as “soft switching”, specifically a zero voltage mode switching inverter for two-way current. Modes in this category limit the losses of energy that occur with each switching operation. They thus make it possible to increase the switching frequency.

In turn, document U.S. Pat. No. 5,432,695A refers to a controlled rectifier/inverter that provides the following characteristics: output voltage regulation, input power factor correction, low harmonic distortion of the currents drawn from the three-phase lines, minimal number of components and minimal components current and voltage stresses, high power density, and high efficiency. Conventionally, for higher power applications, a 3-phase, PWM boost rectifier/buck inverter has been used to meet the above requirements. However, this circuit suffers from severe switching losses and problems with the reverse recovery of the bridge diodes. In order to reduce the size of the reactive components, switching frequency must be increased, which is, however, accompanied with excessive increase of switching losses. The document discloses a three-phase, 6-stepped pulse-width-modulated, boost rectifier/buck inverter circuit including a bridge comprised of three pairs of semiconductor switches with parallel connected diodes connecting respectively a node to which each phase of a three-phase input is connected to a pair of d.c. output rails, one of said semiconductor switches remaining open and one remaining closed during thirty-degree segments of the three-phase input while the remaining semiconductor switches are turned on and off by a pulse-width-modulating signal.

Document US20140159481A1 covers power switches and power diodes arranged as a multilevel inverter (particularly as a two or three level inverter). Wherein the electronic circuit may particularly be configured as a three-phase inverter arrangement. Such a three-phase inverter arrangement may comprise power switches, power diodes, driver circuits, filter circuits and a control unit for generating the pulse-width modulated drive signals being adapted to convert electric energy from DC to three-phase AC, or vice versa.

Such a circuit may be characterized by multiple (n) half-bridges (legs) connected in parallel for every of three grid phases or motor phases, respectively.

### BRIEF DESCRIPTION OF THE INVENTION

The present invention relates to an electronic arrangement of a three-phase frequency inverter with sinusoidal output and variable frequency. The inverter of the present invention exhibits output voltage with low total harmonic distortion, absence of overshoot in the output voltage for any load variation and thus with its precursor, it does not require the use of passive output filters. The innovation consists of a strategic arrangement of diodes, capacitors, inductors and semiconductor switches, as well as a closed-loop PWM control with hysteresis, developing sinusoidal voltages at the output with low total harmonic distortion. The semiconductor switches operate in non-dissipative ZVS (Zero Voltage Switching) and ZCS (Zero Current Switching) switching for most of the switching periods, which causes this DC/AC converter to have superior electrical efficiency and be compatible with industrial applications. The presented topology provides sinusoidal output voltage, eliminating the need for passive output filters and mitigating problems such as burning of the motor related to overvoltages resulting from conventional PWM switching, premature bearing failures, helps reduce excessive vibrations and temperature increases caused by harmonics, has the ability to supply unbalanced loads, reduces irradiated and conducted noise-EMI, mainly in the feeders (cables) that feed the motors, among other benefits. In more detail, the present invention refers to a three-phase inverter comprising six two-way semiconductor switches (S2, S3, S6, S7, S10, S11); six one-way current switches (S1, S4, S5, S8, S9, S12); six inductors (L1, L2, L3, L4, L5, L6); nine diodes (D1, D2, D3, D4, D5, D6, D7, D8, D9); three depolarized capacitors (C1, C2, C3); six feedback resistors (R1, R2, R3, R4, R5, R6); and two symmetrical direct voltage sources (Vdc1, Vdc2) in its main power structure, wherein a sinusoidal output voltage with low harmonic distortion is produced.

Alternatively, twelve two-way current switches are used instead of six one-way and six two-way ones. In generating PWM signals, the aforementioned six resistors and three voltage comparators configured in hysteresis are used, as well as symmetrical 15 Vdc sources. Such two-way switches are used to conduct currents that flow in the opposite direction, ensuring the flow of charge to two direct voltage sources Vdc1 and Vdc2. The diodes present in all the switches associated with the diodes existing in an inverter cell regenerate or dissipate energy through a braking resistor assembly. The three-phase inverter comprises two operating steps that take place simultaneously in each arm, wherein the first stage comprises Δt1 [t1-t0]; and the second stage comprises Δ t2 [t2-t1]. In the said first stage, the switches (S1) and (S2), (S5) and (S6), (S9) and (S10) close, with the closing of each pair being 120 electrical degrees phase shifted relative to each other, the voltages on the output capacitors (C1, C2, C3) begin to grow linearly and the energy stored in the inductors (L1, L3, L5), in association with the input voltage source (Vdc1) supplies energy to them and to the load. The energy stored in inductors L2, L4 and L6 is discharged through the power sources (Vdc1) and (Vdc2), through said diodes (D1, D3, Ds1), antiparallel to the switch (S1), which are directly polarized, being analogous in said diodes (D4, D6, Ds5, D7, D9, Ds9) which are directly polarized, thus allowing demagnetization of the inductors. Closure of the switches (S1, S2) takes place first, after 120 electrical degrees, switches (S5, S6) close and after 240° (or)−120° switches (S9, S10) close, wherein these displacements are inserted into the reference signals, which must be 120° phase shifted relative to each other. In the second stage, when switches (S3, S4, S7, S8, S11, S12) close, closure of these pairs is 120 electrical degrees phase shifted relative to each other and voltages on the output capacitors (C1, C2, C3) begin to decrease linearly to the voltage at their terminals. Part of the energy stored in the inductors (L1, L3, L5) and which is discharged, contributes to the capacitor discharge, also, the association with inductors (L2, L4, L6) and the voltage source (Vdc2) further provides energy for discharging the capacitors and the connected load. Switch (S4) conducts part of the demagnetization current (IL1) that flows through the body diode (Ds4) of this switch, resulting in non-dissipative switching both when opening and closing, wherein the other part of such demagnetization current flows through the inductor (L2) and through the switch (S3), which causes this switch to enter non-dissipative switching in a ZCS mode. The switch (S8) conducts part of the demagnetization current (IL3) that flows through the body diode (Ds8) of this switch, wherein the other part of this current flows through the inductor (L4) and the switch (S7). Similarly, the same occurs in the switch (S12), wherein part of the demagnetization current (IL5) that flows through the body diode (Ds12) is conducted, and the other part of the current (IL5) flows through the inductor (L6) and the switch (S11). In each arm, a part of the demagnetization current is reused in the linear load of its respective output capacitor, and the other part of this current returns to the sources (Vdc). In the said second stage, in non-dissipative ZVS and ZCS switching, before the switches (S4, S8, S12) are set to close, the demagnetization currents (IL1, IL3, IL5) already place the body diodes of these switches in conduction, since the inductors (L1, L3, L5) do not allow an instantaneous variation of current in their terminals; the switches (S1, S5, S9) work in a similar manner when they are set to close. When the said switches (S4, S8, S12, S1, S5, S9) are driven to operate, they close in non-dissipative ZVS (Zero Voltage Switching) switching or zero voltage switching. The closing in non-dissipative ZVS switching of the said switches (S1, S4, S5, S8, S9, S12) ceases to occur in all switch actuation cycles. In periods of negative half-cycles of the generated sinusoids, the switches (S1, S5, S9) operate in non-dissipative ZVS switching both at the conduction input and output. The switches (S4, S8, S12) operate in non-dissipative commutation when opening and closing in all positive periods of generation of the output sinusoids. In ZCS switching, the conduction input in switches (S2, S6, S10) takes place in the negative half-cycle of generation of the inverter output voltages, and in switches (S3, S7, S11) it takes place when the output voltages are generated in the positive half-cycles, with the switches (S2, S6, S10, S3, S7, S11) presenting non-dissipative ZCS switching only in the conduction input. At some moments, switches (S1, S2, S5, S6) will be closed, and switches (S9, S10) will be open, at another moment, switches (S1, S2, S9, S10) will be closed and switches (S5, S6) will be open, at a third moment only switches (S1, S2) will be closed and (S5, S6, S9, S10) open. Control of all semiconductor switches using three hysteresis comparators, each producing PWM signals to activate the four switches in each arm. The three hysteresis comparators are applied using three reference sinusoidal signals, 120° phase shifted relative to each other, with low amplitude, which will be compared to the respective feedback signals sampled from the output terminals of each arm. Said comparisons generate PWM signals that activate the respective semiconductor switches, allowing the creation of three sinusoidal waves at their output terminals, with a module varying according to the change in the amplitude of these feedback signals or by changing the amplitudes of the reference sinusoidal signals. Feedback1, Feedback2 and Feedback3 signals are sent to the inverter inputs of the respective comparators, which are proportional to the output voltages across the capacitors (C1, C2, C3). Furthermore, sinusoidal signals 120° phase shifted relative to each other are connected to the non-inverter terminals of the respective comparators. The three-phase inverter is a voltage-following DC/AC inverter, in which, in the hysteresis control, the generated pulses control the power switches, causing the inverter output voltages to present the same waveforms as the reference signals. Gains of the feedback loops are changed when the ratio between the resistors of the respective resistive dividers, parallel to the capacitors (C1, C2, C3) is modified. An alternative way of gain is by modifying the signal levels of Reference1, Reference2 and Reference3, wherein it is also possible to change frequency of the output signal and the angular phase shift. Furthermore, the outputs of said comparators are connected to a gate driver for each key.

### BRIEF DESCRIPTION OF THE FIGURES

In order to complement the present description and provide a better understanding of the features of the present invention, and in accordance with a preferred embodiment of the present invention, a set of figures is attached herein, which represents, in an exemplary although not limiting manner, the preferred embodiment of the present invention.

FIG. 1 shows the claimed three-phase inverter with grounded Y load, in accordance with a preferred embodiment of the present invention.

FIG. 2 shows the claimed three-phase inverter with an isolated Y load, in accordance with a preferred embodiment of the present invention.

FIG. 3 shows the claimed three-phase inverter with A load, in accordance with a preferred embodiment of the present invention.

FIG. 4 shows the first stage of operation of the claimed three-phase inverter, in accordance with a preferred embodiment of the present invention.

FIG. 5 shows the second stage of operation of the claimed three-phase inverter, in accordance with a preferred embodiment of the present invention.

FIG. 6 shows an example of driving the claimed three-phase inverter, in accordance with a preferred embodiment of the present invention.

FIG. 7 shows a PWM pulse generated in one arm of the claimed three-phase inverter, in accordance with a preferred embodiment of the present invention.

FIG. 8 shows the claimed simulated three-phase inverter with A load, in accordance with a preferred embodiment of the present invention.

FIG. 9 shows a control circuit proposed for generating PWMs, in accordance with a preferred embodiment of the present invention.

FIG. 10 shows line and phase voltages at the output. In the lower part, phase voltage, line and phase current, according to a preferred embodiment of the present invention.

FIG. 11 shows voltages and currents in switches S1, S5 and S9, according to a preferred embodiment of the present invention.

FIG. 12 shows the voltage and current in switch S1, in accordance with a preferred embodiment of the present invention.

FIG. 13 shows the ZVS switching on switch S1, according to a preferred embodiment of the present invention.

FIG. 14 shows voltages and currents in switches S2, S6 and S10, according to a preferred embodiment of the present invention.

FIG. 15 shows the voltage and current in switch S2, in accordance with a preferred embodiment of the present invention.

FIG. 16 shows the ZCS switching on switch S2, according to a preferred embodiment of the present invention.

FIG. 17 shows the current balance during the discharge period of (C1), according to a preferred embodiment of the present invention.

FIG. 18 shows currents and voltages in diodes D1, D5 and D9, according to a preferred embodiment of the present invention.

FIG. 19 shows currents and voltages in inductors L1, L3 and L5, according to a preferred embodiment of the present invention.

FIG. 20 shows line and phase voltages with amplitude variation over time, 100 Hz, in accordance with a preferred embodiment of the present invention.

FIG. 21 shows line and phase voltages of 30 Hz, 120 Hz and 500 Hz, DF (Damping Factor)=−20, according to a preferred embodiment of the present invention.

FIG. 22 shows the unbalanced A load, DF=−20, according to a preferred embodiment of the present invention.

FIG. 23 shows the voltage, current and trigger pulses at the output with thyristors, according to a preferred embodiment of the present invention.

FIG. 24 shows line and phase voltages, phase currents in Δ load, according to a preferred embodiment of the present invention.

FIG. 25 shows line currents in Δ load, according to a preferred embodiment of the present invention.

FIG. 26 shows the unbalanced grounded Y load, DF=−20, according to a preferred embodiment of the present invention.

FIG. 27 shows line and phase voltages and line currents in the grounded Y load, according to a preferred embodiment of the present invention.

FIG. 28 shows the unbalanced Y load with isolated neutral, DF=−20, according to a preferred embodiment of the present invention.

FIG. 29 shows line and phase voltages and line/phase currents in the grounded Y load, according to a preferred embodiment of the present invention.

FIG. 30 shows measurement points for voltages VAN′, VBN′, VCN′ and VN′0, in accordance with a preferred embodiment of the present invention.

In FIG. 31, voltages VAN′, VBN′ and VCN′ are represented and below the voltage VN′0, according to a preferred embodiment of the present invention.

FIG. 32 shows line voltages; phase voltages; voltages between phase and neutral and between ground and neutral, in accordance with a preferred embodiment of the present invention.

FIG. 33 shows the yield with isolated and unbalanced Y load, according to a preferred embodiment of the present invention.

FIG. 34 shows the yield with resistive A load, according to a preferred embodiment of the present invention.

FIG. 35 shows the yield with resistive load in Δ, frequency of 20 Hz, 200 Hz and 1 kHz, according to a preferred embodiment of the present invention.

FIG. 36 shows the yield with a grounded Y resistive load, frequency of 20 Hz, 200 Hz and 1 kHz, according to a preferred embodiment of the present invention.

FIG. 37 shows the components of the claimed inverter: 2 units of Symmetrical DC sources (5); twelve units of resistors (8); six units of simple semiconductor switches; three units of depolarized capacitors (4); three units of hysteresis comparators (7); nine units of fast recovery diodes (6); six units of inductors with ferrite core (3); six units of two-way current semiconductor switches (1), according to a preferred embodiment of the present invention.

FIG. 38 shows the control circuit of the claimed inverter, in accordance with a preferred embodiment of the present invention.

### DETAILED DESCRIPTION OF THE INVENTION

The present invention relates to a three-phase ECD inverter comprising the following assembly form: the positive terminal of the Vdc1 source connects to the cathode of diode D2 and to the drain or collector (depending on the switch used, Mosfet, IGBT, and so on.) of the two-way current switch S1; the source/emitter terminal of switch S1 connects to the cathode of diode D1 and to a terminal of inductor L1; the other terminal of inductor L1 connects to the anode of diode D2 and to the drain/collector of single switch S2; the source/emitter terminal of switch S2 connects to one of the terminals of the capacitor (C1), one of the terminals of the load to be powered and to the drain/collector of the simple switch (S3); the source/emitter terminal of the switch (S3) is connected to the cathode of diode D3 and to one of the terminals of inductor L2; the other terminal of inductor L2 is connected to the anode of diode D1 and to the drain/collector of switch (S4); the source/emitter terminal of switch (S4) is connected to the anode of diode D3 and to the negative terminal of Vdc2 source; then, there is the connection between the negative terminal of the Vdc1 source, the other terminal of the capacitor (C1), the other terminal of the load and the positive terminal of Vdc2 source, these points being grounded. In parallel to the capacitor (C1) and the load, two resistors R1 and R2 are placed in series, and a voltage sample is taken from the middle of such resistive divider and sent directly to the inverting input of the hysteresis comparator. A resistor R3 receives the signal to be obtained at the inverter output, in this instance, a low voltage sinusoidal signal is placed, which is designated as reference. The other end of resistor R3 is interconnected to the non-inverter input of the hysteresis comparator and resistor R4. The other end of resistor R4 is connected to the output connector of the hysteresis comparator, closing the PWM signal generating loop. The generated PWM signal is sent to switches S1, S2, (S3) and (S4), however for switches (S3) and (S4) it must be inverted. Switches S1 and S2 work by closing together, and to the opposite, switches (S3) and (S4) also close together, but only after switches S1 and S2 open, hence the need to invert the pulses that go to switches (S3) and (S4). The four PWM signals must first pass through galvanic or optical isolation drives to be able to actuate the four semiconductor switches. Furthermore, two other electronic systems identical to the one mentioned above are assembled, using the same symmetrical sources Vdc1 and Vdc2 to feed such other two systems and interconnecting the ground of the three structures.

In particular, the present invention relates to an electronic arrangement of a three-phase frequency inverter with sinusoidal output and variable frequency, this topology presents output voltage with low total harmonic distortion, absence of overshoot in the output voltage for any load variation and hence with its precursor, it does not require the use of passive output filters.

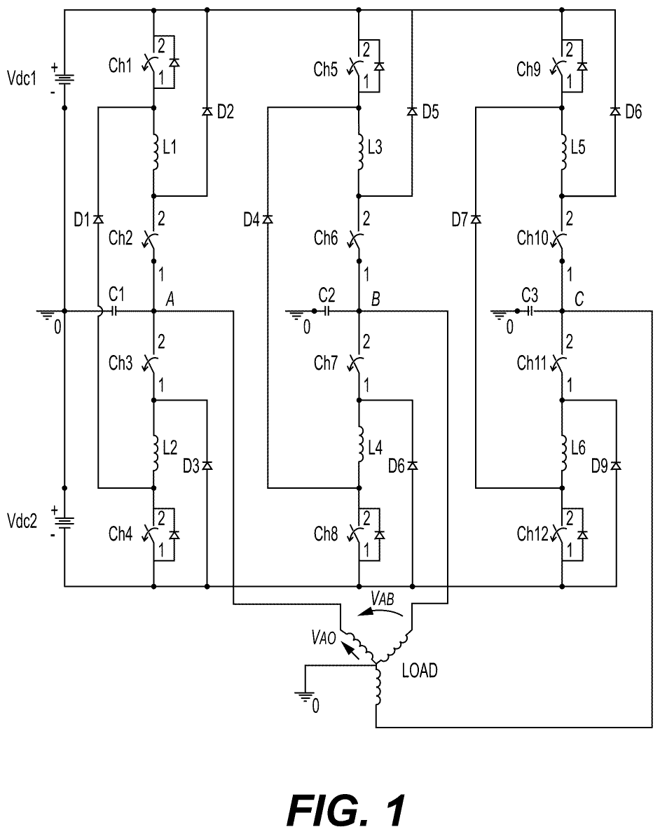

The Three-Phase Inverter of the present invention, as seen in FIG. 1, is composed of the appropriate grouping of three single-phase ECD inverters, configured and joined in such a way as to enable the connection of loads to their terminals in any known three-phase configuration. The following are the three main load configurations or connections to be connected to the output of the three-phase inverter, according to a preferred embodiment of the present invention.

The first one to be presented is the grounded Star (Y). The Three-Phase Inverter of the present invention provides maximum RMS values at line voltages VAB, VBC and VCA of the order of Vdc÷\sqrt{2}×\sqrt{3} and phase voltages, VA0, VB0 and VC0 of the order of Vdc+\sqrt{2}.

Connecting the load in a grounded star allows for balance between the currents flowing between balanced loads and a drainage point for currents in the case of unbalanced loads.

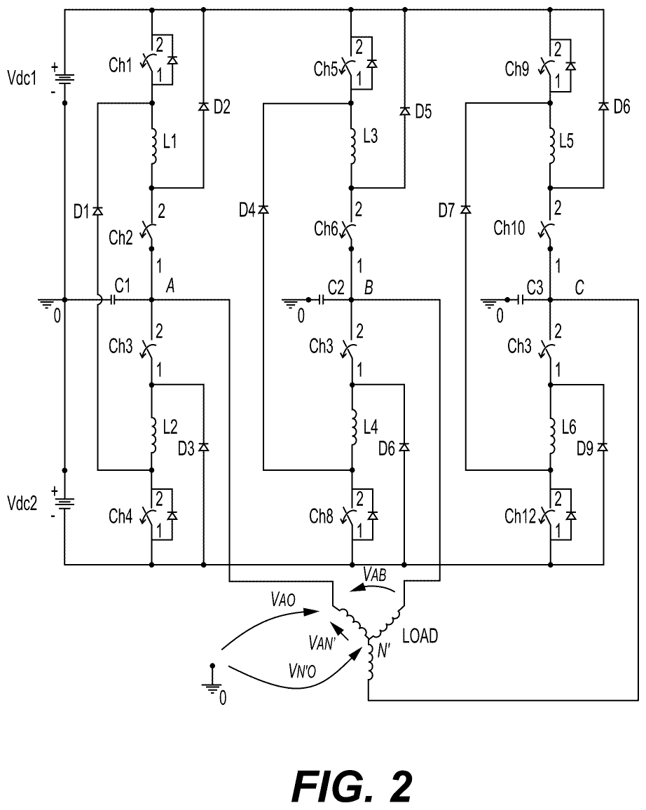

In the second configuration, as noted in FIG. 2, the load connection is made in an isolated Star (Y), without the neutral being connected to ground. In this configuration, it can be seen that the line voltages VAB, VBC and VCA, as well as the phase voltages VA0, VB0 and VC0 measured to the ground remain unchanged in any load status, whether balanced or unbalanced, presenting the same module values as indicated for the grounded Star configuration.

However, the same does not apply to the assessment of voltages that are measured between the phases and the center of the star when unbalanced loads are connected to its terminals. These voltages, designated herein as VAN′, VBN′ and VCN′, will undergo changes in magnitude depending on the imbalance imposed by the loads, as demonstrated below.

Another fact to be observed is due to the appearance of a voltage measured between the ground and the center of the star, which is designated herein as VN′0 as seen in FIG. 2.

Such observations are not indicative of inverter failure or malfunction, as they merely reflect an inherent characteristic of the system of unbalanced loads that are connected in this type of configuration.

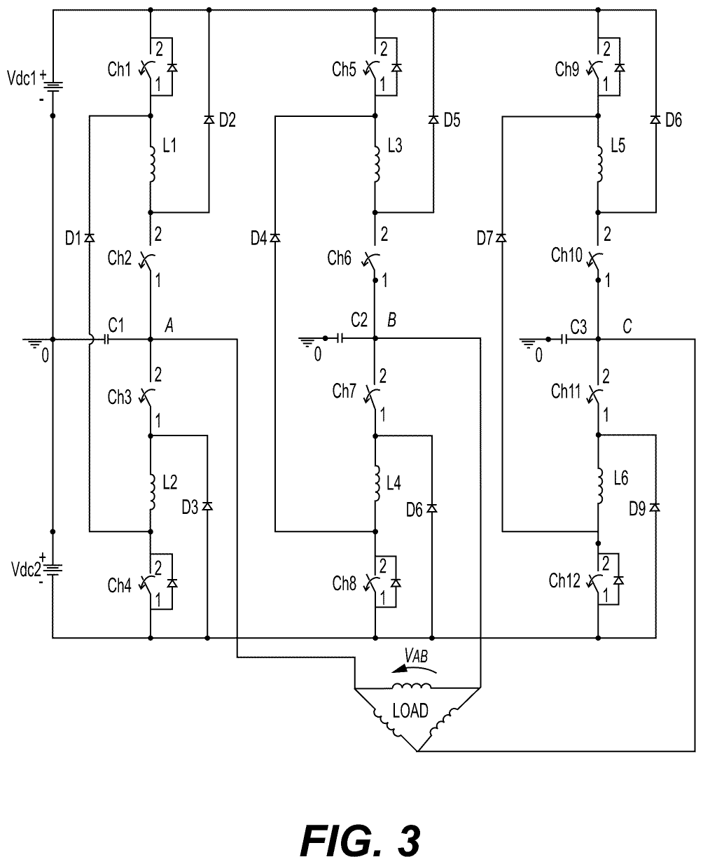

FIG. 3 shows the Delta or Triangle connection of the load, which is very commonly used in industrial facilities. The triangle connection of the load is widely used as it does not require a fourth cable to be routed to the motor connection box.

Compared to the star connected load, here in the triangle connection, each phase of the load must now support a voltage 3 times higher, the amplitude of the current that runs through it also being 3 times higher.

Therefore, before using this type of inverter, the load's capacity to receive this level of voltage and consequent current must be carefully observed, as will be described later. The operating capacity as well as the specificities of the new inverter supplying balanced and unbalanced loads will be demonstrated below.

Creation of the claimed inverter was possible thanks to the connection of three single-phase inverters arranged in such a way as to use only two symmetrical power sources and the use of three comparators with reference voltages 120° phase shifted, creating a new three-phase inverter that allows loads to be supplied in three-phase configurations.

The reference voltages applied to the controls of each arm must be phase shifted by 120° electrical degrees, have the same frequency and the same module so that balanced three-phase voltages are supplied to the load. However, the use of this new inverter goes beyond three-phase sinusoidal generation, making it possible to create countless possibilities of three-phase voltages, with varied amplitudes, frequencies and angular phase shifts in each arm, indistinctly.

The claimed three-phase inverter is composed of six two-way and six one-way current semiconductor switches, six inductors, nine fast diodes, three depolarized capacitors and six feedback resistors and two symmetrical direct voltage sources in its main power structure. When generating the PWM signals, six resistors and three voltage comparators configured in hysteresis are used, as well as the symmetrical 15 Vdc sources that power these comparators.

Regarding semiconductor switches, the single-phase ECD inverter from patent application BR 10 2023 013005 4 has as one of its characteristics the mandatory use of two-way current switches for those switches connected directly to the Vdc1 and Vdc2 sources. In the other two semiconductor switches that interconnect with the output capacitor, the use of one-way switches is permitted.

However, the use of all switches being two-way semiconductor switches is possible and recommended, being both in simulation and in practice the best option of application. This is because it prevents and reduces possible electrical differences between the characteristics of the switches that could hinder the proper switching of the arms and allows the current to flow in cases where three-phase motors return energy, such as in the event of a short circuit or in instances where energy is regenerated for some reason.

Using all two-way switches allows the conduction of currents that flow in the opposite direction, ensuring their flow from the load to the direct voltage sources Vdc1 and Vdc2, which does not hinder the perfect operation of the inverter.

It can be achieved due to the existence of body diodes present in all switches associated with the diodes existing in the inverter cell, enabling the regeneration of this energy or even dissipating it through a strategically placed braking resistor assembly.

In a preferred embodiment, it is also possible to describe two operating stages for the claimed three-phase inverter, which occur simultaneously in each arm:
First Stage: Δt1 [t1−t0]

When switches S1 and S2, S5 and S6, S9 and S10 close, closure of each of these pairs being 120 electrical degrees phase shifted relative to each other, the voltages on the output capacitors (C1), (C2) and (C3) begin to grow linearly, since the energy stored in the inductors L1, L3 and L5, in association with the input voltage source Vdc1, supplies energy to them and to the load.

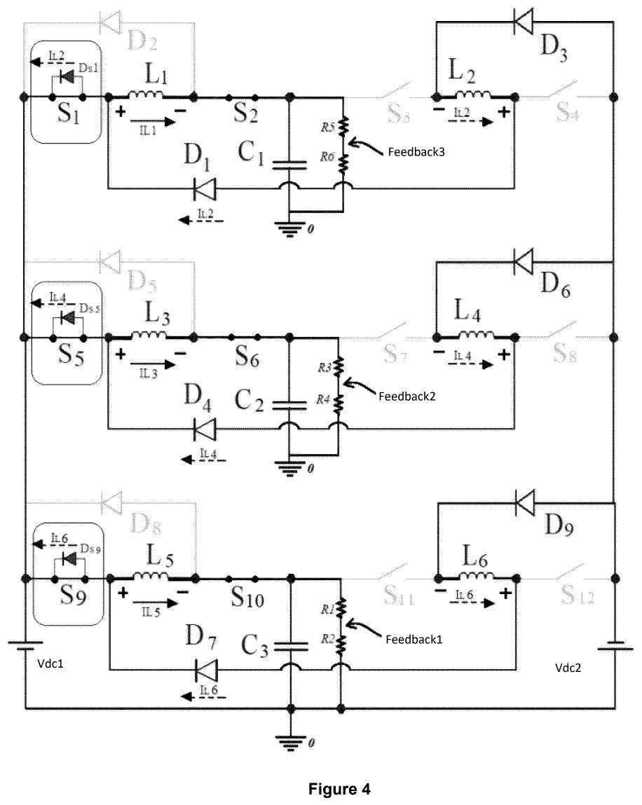

As seen in FIG. 4, which comprises this stage of operation, if energy is stored in inductors L2, L4 and L6, such energy is discharged through power sources Vdc1 and Vdc2, by means of diodes D1, D3 and Ds1 (antiparallel diode of switch S1), which are directly polarized.

The same is true with the other diodes D4, D6 and Ds5 as well as D7, D9 and Ds9 which are directly polarized and allow the demagnetization of the inductors.

It is worth noting that the closure of switches S1 and S2 takes place first, after 120 electrical degrees, switches S5 and S6 close, and after 240° (or)−120° switches S9 and S10 close, ensuring the correct three-phase angular phase shift between the generated signals. These shifts must be inserted into the reference signals, which must be 120° phase shifted relative to each other. Furthermore, the second stage comprises:
Second Stage: Δt2 [t2−t1]

When switches (S3) and (S4), (S7) and (S8) and (S11) and (S12) close, closure of these pairs being 120° electrical degrees phase shifted relative to each other, voltages on the output capacitors (C1), (C2) and (C3) begin to decrease linearly to the voltage at their terminals.

Part of the energy stored in inductors L1, L3 and L5, and which is being discharged, contributes to this discharge of the capacitors, as well as the association with inductors L2, L4 and L6 and the voltage source Vdc2, which can also provide energy for the discharge of capacitors and the connected load.

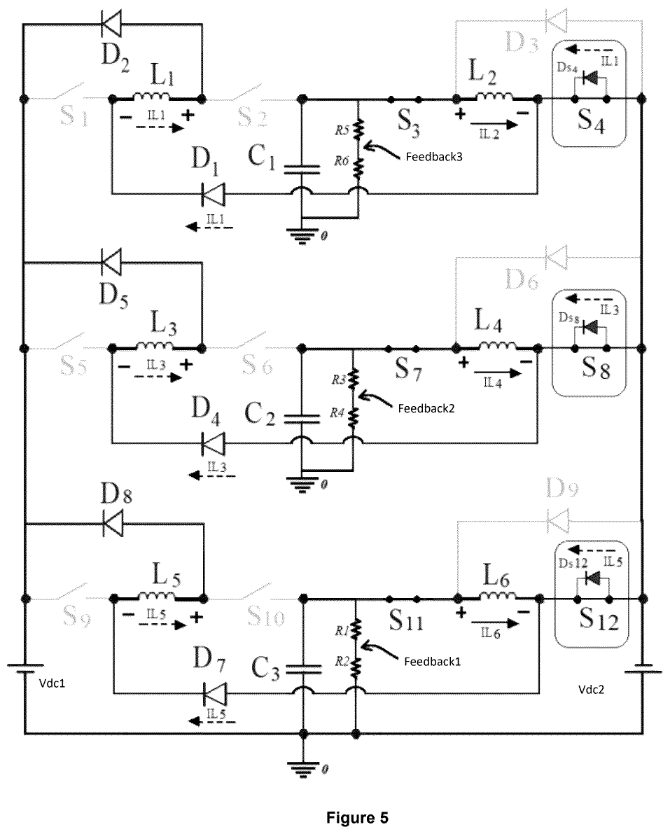

The paths taken by the discharge currents are seen in FIG. 5. Switch (S4) conducts part of the demagnetizing current IL1 that flows through the body diode D (S4) of this switch, which results in the beneficial non-dissipative switching or also designated as ZVS (Zero Voltage Switching) soft switching both at opening and closure, with the other part of this demagnetization current flowing through the inductor L2 and the switch (S3), which causes this switch to enter non-dissipative switching in ZCS mode (Zero Current Switching).

Following the same operating principle, the switch (S8) conducts part of the demagnetization current IL3 that flows through the body diode D (S8) of this switch, with the other part of this current flowing through the inductor L4 and the switch (S7). The same occurs in the switch (S12), which conducts part of the demagnetization current IL5 that flows through the body diode D (S12), with the other part of the current IL5 flowing through the inductor L6 and the switch (S11).

In each arm of the inverter, part of the demagnetization current is reused in the linear load of its respective output capacitor, and the other part of this current actually returns to the Vdc sources.

Specifically regarding non-dissipative ZVS and ZCS switching, important observations must be made for both steps presented above. Taking the second stage as an example, just before the switches (S4), (S8) and (S12) are set to close, the demagnetization currents IL1, IL3 and IL5 already place the body diodes of these switches in immediate conduction, due to the inductors L1, L3 and L5 that do not allow instantaneous variation of current in their terminals. The same applies to switches S1, S5 and S9 when they are set to close.

Thus, when these switches are set to operate, they will close in non-dissipative ZVS (Zero Voltage Switching) switching or zero voltage switching, since the current was flowing through the body diodes, thus ensuring their closing with zero voltage.

The ZVS closure of switches S1 and (S4), S5 and (S8), S9 and (S12) does not occur in all switch actuation cycles. However, the non-dissipative switching seen already acts as a great ally in increasing the inverter's efficiency and reducing electromagnetic interference-emitted and irradiated EMI, reducing the high di/dt and dv/dt inherent to the switching of controlled semiconductor devices.

An important fact to be pointed out is the ZVS switching in the negative half-cycle of generation of the inverter output voltages for switches S1, S5 and S9, and in the generation of the positive half-cycle for switches (S4), (S8) and (S12) of the sinusoidal output signal.

During all periods of negative half-cycles of the generated sinusoids, switches S1, S5 and S9 operate in non-dissipative ZVS switching both at the conduction input and at the conduction output, as will be seen later in simulation. It will also be noted that conduction of the current in these periods is carried out by the body diode of these switches in these periods.

The same occurs with switches (S4), (S8) and (S12) that operate in non-dissipative switching when opening and closing in all positive periods of generation of the output sinusoids.

Non-dissipative switching is also seen in the activation of switches that are connected to the output capacitors, namely S2, S6 and S10 as well as (S3), (S7) and (S11), however, exhibiting ZCS switching or zero current switching as a soft switching feature.

The ZCS switching at the conduction input in switches S2, S6 and S10 occurs in the negative half-cycle of generation of the inverter output voltages, and in switches (S3), (S7) and (S11) the ZCS switching at the conduction input occurs when the output voltage generations are in positive half cycles. The switches shown above exhibit ZCS non-dissipative switching only at the conduction input.

This fact can be explained, for example, because in the positive period of generation of the sinusoidal voltage, when the output capacitor voltage decreases linearly, there is a discharge of high current from inductor L1 through the body diode of switch (S4) and also through switch (S3) through inductor L2, causing the voltage in the output capacitor to decrease linearly.

Accordingly, the presence of inductor L2, which does not allow instantaneous variation of current at its terminals, causes the current to rise linearly in the switch (S3), as current IL1 decreases and IL2 increases and drains part of this current, causing switch (S3) to enter ZCS conduction mode.

The same happens in switches (S7) and (S11), which switch in ZCS mode at the conduction inputs and in switches S2, S6 and S10 which also operate in ZCS mode when closing, following the same reasoning.

It is interesting to verify this fact in the currents, which have very different values in switches (S3) and (S4), for example. In the positive period of generation of the sinusoidal voltage, even though they are in series, current in the switch (S4) (and which circulates through the body diode of this switch) is given by subtracting the current that comes from the inductor L1 (and which circulates through the diode D1) by the current that passes through the inductor L2 and consequently through the switch (S3).

The ZVS and ZCS characteristics were thus observed in the claimed inverter in all its switches, at specific times, constituting one of the factors that led this new inverter to deliver high yields and reduced electromagnetic generation and interference effects.

Regarding the characteristics of actuation, it is also important to check in the operating stages that if an analysis of the signal from the switches in the same position in each arm, for example, S1 and S2, S5 and S6 and S9 and S10 is made over time and the three PWM signals generated simultaneously are noted, different closing configurations will be seen in some periods between them, which takes place due to the angular phase shift of 120° between the inverter arms.

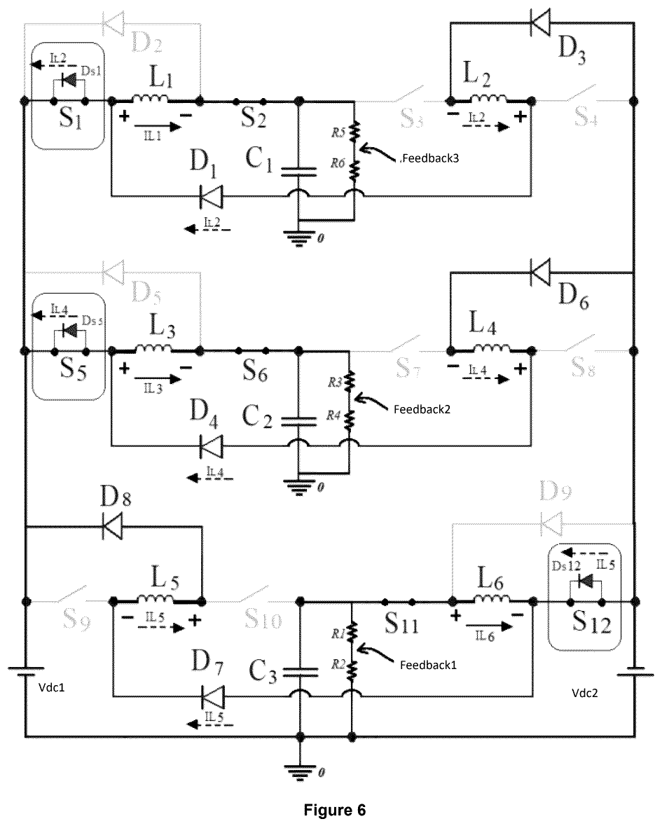

On certain occasions switches S1 and S2 and S5 and S6 will be closed, and switches S9 and S10 will be open, as shown in FIG. 6. Δt another time, switches S1, S2, S9 and S10 are closed and switches S5 and S6 are open. Δt another time, only switches S1 and S2 will be closed and S5 and S6 and S9 and S10 will be open.

Other closing possibilities will also be seen, totaling nine different states or possibilities of activations between pairs.

To control all semiconductor switches, three hysteresis comparators are used, each producing the PWM signals to activate the four switches on each arm.

To be applied, using three reference sinusoidal signals 120° phase shifted relative to each other with low amplitude are necessary, which will be compared to the respective feedback signals sampled from the output terminals of each arm of the inverter.

These comparisons generate PWM signals that are used to activate the respective semiconductor switches, and allow the creation of three sinusoidal waves at their output terminals, with a module varying according to the change in the amplitude of these feedback signals or by changing the amplitudes of the reference sinusoidal signals. Both variations act to change the amplitude of the sinusoidal signals created.

The captured samples are proportional to the output voltages on the capacitors (C1), (C2) and (C3) and are designated as Feedback1, Feedback2 and Feedback3 signals that are sent to the inverting inputs of the respective comparators. The non-inverting inputs receive the reference signals, herein designated as Reference1, Reference2 and Reference3.

These reference signals will be reproduced at the inverter output, with adequate amplitude and capacity to supply sufficient power to a three-phase load. Therefore, sinusoidal signals that are 120° phase shifted relative to each other must be connected to the non-inverting terminals of the respective comparators.

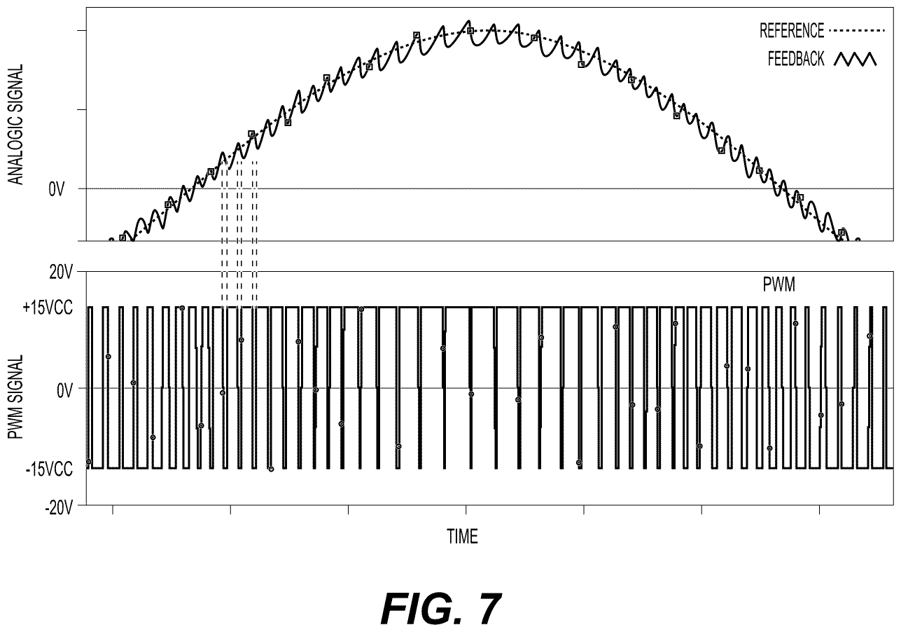

In hysteresis control as seen in FIG. 7, the generated pulses control the power switches, causing the output voltages of the three-phase inverter to present the same waveforms as the reference signals, characterizing the proposed topology as a voltage-following dc/ac inverter.

As previously discussed, gains of the feedback loops are changed when the ratio between the resistors of the respective resistive dividers, parallel to the capacitors (C1), (C2), (C3) is modified. Another way to change the gain in this topology is by modifying the levels of Reference1, Reference2 and Reference3 signals. This alternative is the most recommended, as it is where we can also change the frequency of the output signal and the angular phase shift.

It is important to act on the simultaneous variation of the three reference signals in both frequency and amplitude, otherwise output sinusoids that are not perfectly equal and balanced will result, generating an unbalanced voltage system.

Given the voltage follower characteristic of the claimed three-phase inverter, it can be inferred that it is also possible to generate other types of voltage at the output of such inverter. Thus, if an audio signal, a triangular wave, a square wave or other varied electrical signals are applied, for example, to the non-inverting input of the comparators, the claimed three-phase inverter is capable of reproducing these waveforms at the output. Responding however with high harmonic distortion in the output signal for the frequency spectrum of the order of kilo-hertz or higher.

It should be emphasized that the comparators outputs must be connected to a gate driver for each switch. The gate driver circuit is responsible for isolating the pulses, since the reference potential of each level of the inverter is different, and is also responsible for inverting them and conditioning them.

A common characteristic that some commercial inverters present and that can be considered a problem for sensitive loads is the non-sinusoidal characteristic of the voltage generated at their output. Several topologies used in the process of generating this voltage present a sinusoidal waveform with great distortion, or even a square waveform with levels or steps that soften the harmonic content, but which still do not give the output voltage a legitimate sinusoidal characteristic.

When using a non-sinusoidal inverter, several problems may arise in the installation and in the motor, including: degradation of the coil isolation and the burning of motors due to the voltage wave reflection; failure in bearings due to capacitive discharge due to output harmonics; high acoustic noise; increased electrical losses and motor temperature; need to use derating of motor power due to harmonics; increased vibration level; loss of performance and change in engine slip; high electromagnetic interference (EMI), among others.

All of the above-mentioned issues are caused by the use of inverters with non-sinusoidal output and can occur in industrial facilities, impairing the plant's operation and causing a reduction in the service life of the TIM.

In Karavasilis, R. G. (“Study of Motors Driven by Frequency Converters and Influences on the Insulating System.” Dissertation in Electrical Engineering, Federal University of Santa Catarina, 2008) a 2500 HP engine was driven through a medium voltage converter to 6 ΩHz in scalar mode (V/F), with load provided by a dynamometer, which was adjusted to provide the nominal value of the engine. The engine temperature rise was recorded until thermal stabilization for 100% load torque and with the engine at 6 ΩHz.

Upon observing the values obtained in the laboratory and comparing them for the two established conditions (with and without converter), it can be seen that the temperature rise in one of the motor windings when it was driven through a frequency converter was up to 9.9° C. higher than the condition in which the motor is driven directly from the power supply network.

As presented by Karavasilis, R. G. (table 4.7), it was also noticed that the increased temperature rise in the motor windings was always greater than 5.8° C. for the condition using the frequency converter. The motor's power factor was also significantly reduced when the inverter was used. The same happened with the yield, which was also reduced.

According to the Arrhenius Law, whereby a 10° C. increase in the usage temperature leads the failure time to drop by half, we can then infer that a 9.9° C. increase will have a significant impact on the service life of the TIM.

Another problem that can be seen in industrial plants is related to electromagnetic interference (EMI). The high EMI produced in many cases causes problems in the installation itself and in the surrounding area, forcing the inverter owner to apply mitigating solutions, sometimes by reducing the inverter's switching frequency, sometimes by installing filters, such as reactors, sinusoidal filters, dV/dt filters, RC, LCL, etc., output transformers, among other actions.

The use of filters can lead to complex tuning adjustments, undue resonances, increased weight in cabinets, difficulty or even impossibility of paralleling two or more inverters due to electrical differences between filter values, narrowing of the working range of the output frequency, among other problems.

Thus, development of the three-phase inverter of the present invention aims to mitigate these many severe problems by producing sinusoidal output voltage with low harmonic distortion.

### Examplary Embodiment/Tests/Results

To validate operation of the ECD Three-Phase Inverter, a computational analysis was developed using the purchased Orcad® 2022 software. Other electronic circuit simulation software such as Proteus, Psim, Pscad, Multisim, etc., can be used for the same purpose.

The behavior of the new inverter was evaluated based on its waveforms, in particular, output voltages and currents, voltages and currents on the semiconductor switches, diodes and yield. The components in Table 1 below were used:

TABLE 1
Simulation Parameters

| | | | | |
|---|---|---|---|---|
| CC Sources | 125 | Vcc | 2 | units |

| (Voltage Sources) | | | |
|---|---|---|---|
| Diodes | R7S21007 | 9 | units |
| Mosfets | IRFP254 | 12 | units |

| | | | | |
|---|---|---|---|---|
| Inductors | 500 | μH | 6 | units |
| Capacitor | 100 | μF | 3 | units |
| Resistor | 65 | kΩ | 3 | units |
| Resistor | 1.9 | kΩ | 3 | units |

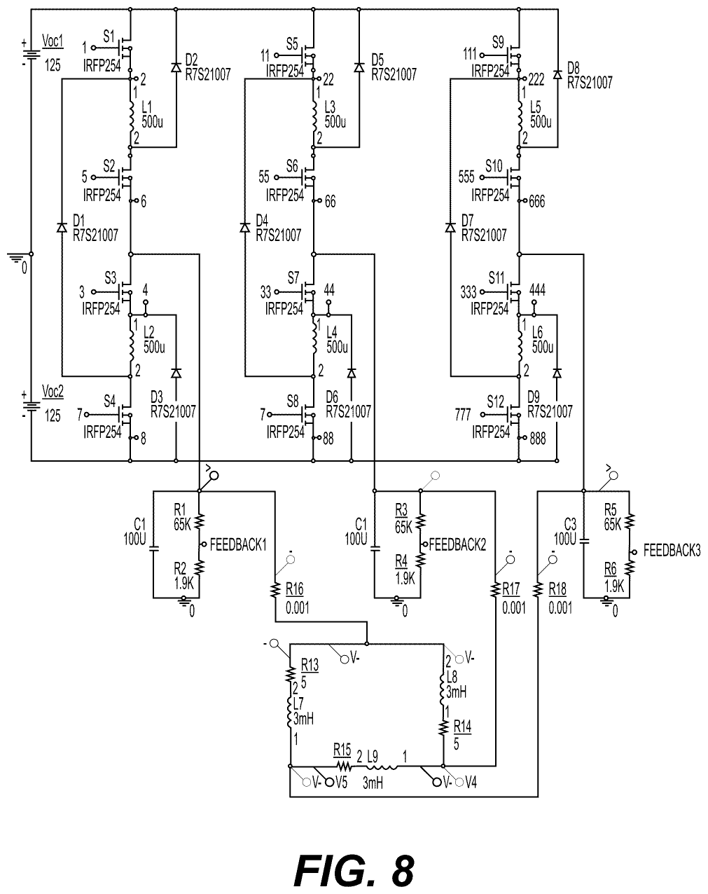

These are the components of the power part that comprises the simulated ECD Three-Phase Inverter and which are seen in FIG. 8. The connection chosen for the load in this case was the triangle connection (A), which is the most common in industrial applications. Three 0.0010 resistors were used in each phase, R16, R17 and R18, which were placed only to allow the connection of the current probe, enabling the reading of the line current drained by the load.

As a balanced load at the output, a 5Ω resistor in series with a 3 mH inductor was initially used in each phase, with the output frequency set to 100 Hz.

In the output signal feedback, 65 KΩ resistors were used in series with 1.9 KΩ resistors in each phase, which resulted in an approximate gain of 35.2, given by dividing 65 plus 1.9, divided by 1.9. The peak value of the phase-to-ground output voltage of each phase has therefore reached a value of:

$$V LNpk = 35.2 * 3 \approx 105.6 V$$

Where each phase is responsible for generating a sinusoid with a peak of 105.6 V between phase and ground, this value being given by multiplying the values of Reference1, Reference2 and Reference3 (3 Vpk) by the gain of the Feedback loop (35.2) of each phase.

The peak value of the line voltage over the triangle connected load reached a value of:

$$V LLpk = 105.6 * √ 3 \approx 182.9 V$$

Thus, a gain of \sqrt{3} times the Vdc voltage is achieved in this type of connection, resulting from the triangle connection of the load due to the specific characteristics of this inverter.

Motors that can be connected in Δ/Y have a star voltage (Y) \sqrt{3} times higher than the delta voltage (Δ). Using this same motor in the three-phase ECD inverter, if it is closed to star, the voltage at the motor terminals will be the line voltage, \sqrt{3} higher than the phase-to-ground voltage.

However, if it is triangle connected, winding of this motor, which was sized to receive the phase voltage, will be subjected at its terminals to the line voltage, that is \sqrt{3} times higher than its specification, resulting in overheating and burning of the winding.

Therefore, attention should be paid to the specificity of this inverter, requiring a study by the customer and the manufacturer at the time of use.

Implementation of a specific parameterization in the control, changes in the Vdc voltage of the input sources, among other solutions, can be studied and carried out with a view to using Y/A motors without the need to consider the fact described above.

Three voltage comparators of the LM318 type configured in hysteresis were used in the control and generation of the trigger pulses.

Other comparators such as RC4559, LM218, among others, with high slew/rate characteristics can also be applied. Each of these comparators will generate a pulse train 120° phase shifted relative to each other. The use of twelve voltage isolation drivers was necessary in this simulation, being responsible for isolating the PWM signals generated and triggering the switches.

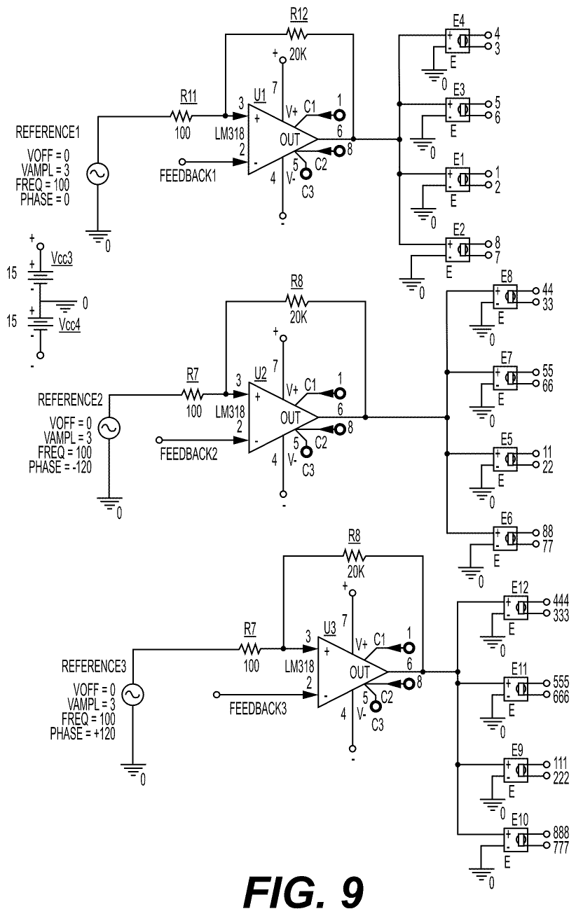

As seen in FIG. 9, it is observed that 120° phase shifts were inserted in the reference signs, shifting the phases of the reference signals. 1000 and 20 kQ resistors were used in the hysteresis loop in all comparators. Voltage frequencies and amplitudes in the three references must be changed altogether and have the same value.

The same logic applies to hysteresis resistors, which must be changed accordingly in order to create a balanced three-phase circuit.

However, as already discussed, different output voltages can be generated with this new inverter. Using different frequencies, phases, amplitudes and waveforms in the references allows the creation of various unbalanced three-phase output waveforms, with high harmonic content, among other infinite possibilities, given its voltage follower characteristic. Various studies, with a view to special tests on loads with different characteristics, can be carried out using the ECD Three-Phase Inverter.

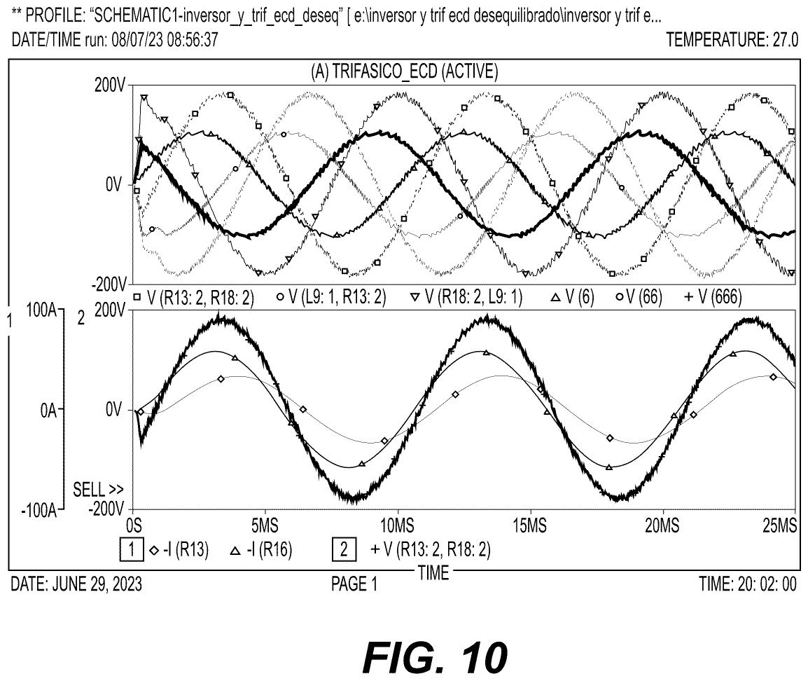

In sequence, as can be seen in the upper part of FIG. 10, are the line voltages and phase voltages at the output of the new three-phase inverter, and in the lower part, the line voltage wave, current phase and line current over one of the arms of the triangle connected load.

A balanced load was connected to each phase, the same inductive load as previously indicated, which is equivalent to an impedance of 5+j1.8850, at a frequency of 100 Hz. It can be seen that the voltages generated are sinusoidal with low harmonic distortion and follow the sinusoidal voltages applied to the references, 120° phase shifted with each other. The 30° phase shift between the line and phase currents of the load that are typical of triangle connections, as well as the delay in relation to the voltage due to the inductive characteristic of the connected load.

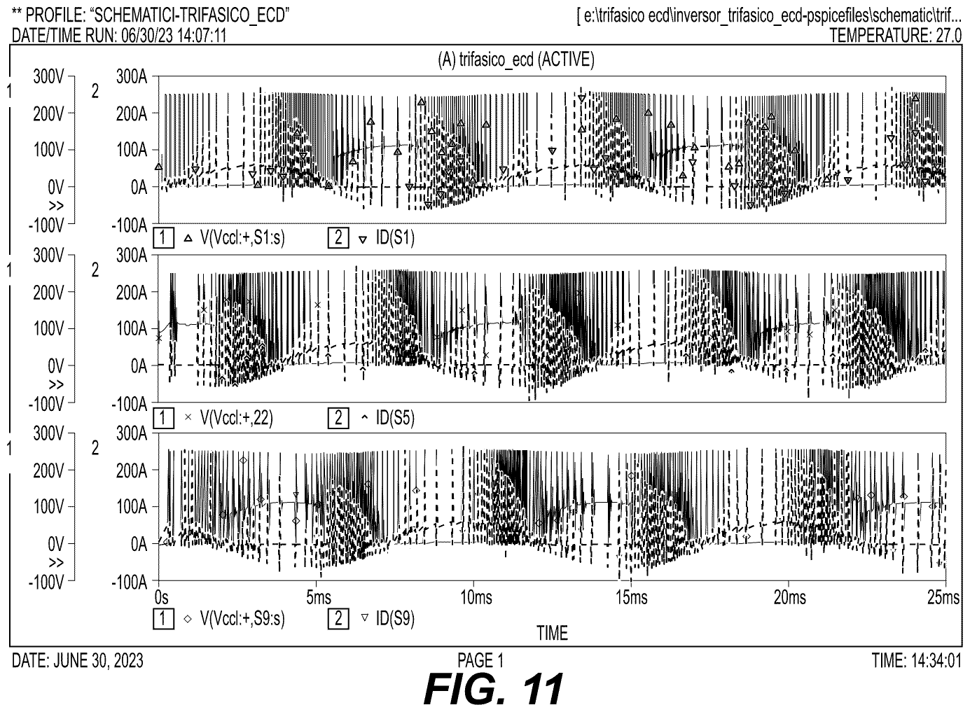

Furthermore, as seen in FIG. 11, there are voltages and currents in the two-way switches S1, S5 and S9. The waveforms at switches (S4), (S8) and (S12) are similar to those shown in FIG. 11, but shifted by 180° and therefore will not be plotted here in this document.

It is observed that the maximum voltage across these switches reaches an approximate value of 250 V, this value being given by the sum of the voltages of the two Vdc sources. Currents in these MOSFETs have reached maximum peaks at 6Ω A conduction and in the switching transients, current values of the order of 250 A were found.

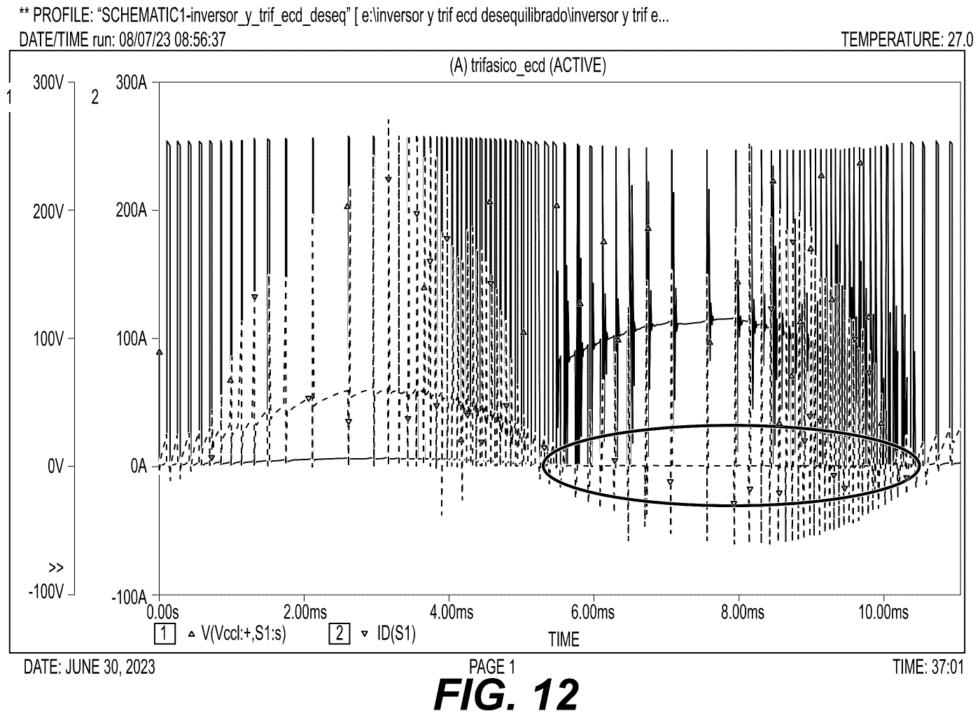

Furthermore, as seen in FIG. 12, current and voltage in switch S1 are highlighted by the ellipse, the ZVS switching (Zero Voltage Switching) in the negative half-cycle of output voltage generation. Current in this stage is conducted by the body diode of this switch and applies similarly to switches S5 and S9. In switches (S4), (S8) and (S12) ZVS switching is also present following the same reasoning, however, it is seen when the positive half-cycle of the output voltage is formed.

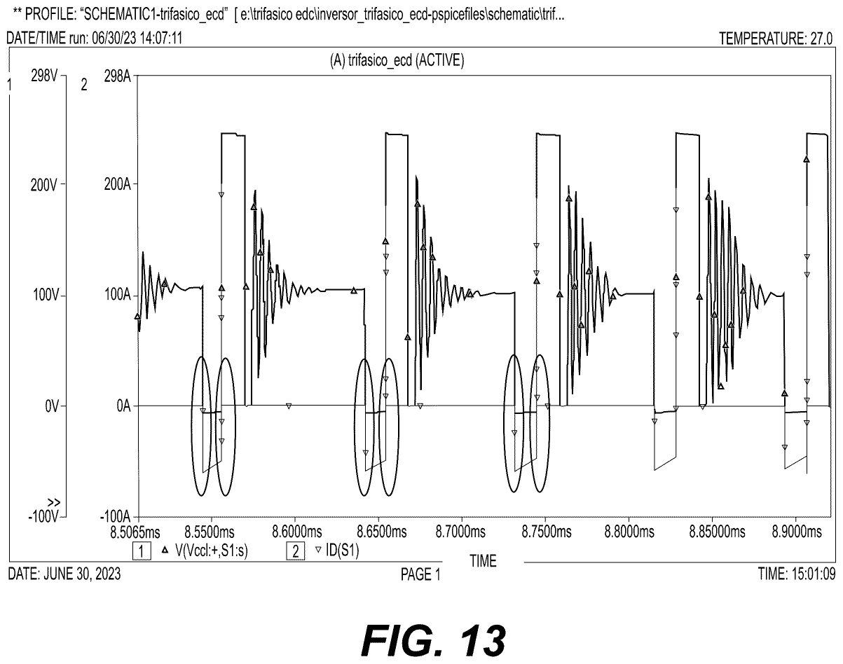

In FIG. 13, a magnification of the voltage and current of switch S1 can be observed, indicating through the ellipses the non-dissipative switching in ZVS that occurs in this switch.

The circulating current occurs through the body diode of switch S1 as can be seen by its negative value in the waveform. A high frequency oscillation is observed in the voltage across switch S1 which must be mitigated using a snubber.

Transient current spikes are also observed in FIG. 13 at the conduction output for blocking, which may be related to the body diode characteristic of the IRFP254 Mosfet, among other possible reasons. This should not occur due to the ZVS switching that should be present in this inverter both when opening and closing the specified switches and which, therefore, will not appear when using more current semiconductor switches.

The choice of the IRFP254 switch, a MOSFET with older technology, was necessary in these simulations due to limitations imposed by the software. Restrictions on the number of electrical nodes that are exceeded in the purchased version, when using other more current Mosfets, did not allow the simulation of the three-phase ECD inverter to be processed with more modern semiconductors.

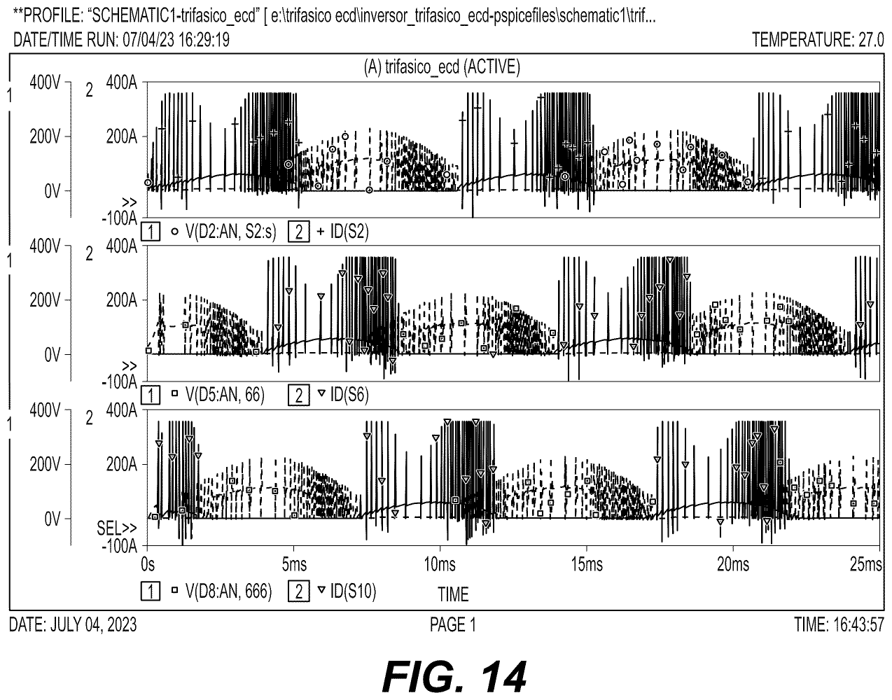

In advance, the voltages and currents in the two-way switches S2, S6 and S10 are displayed. The waveforms at switches (S3), (S7) and (S11) are similar to those shown in FIG. 14, but shifted by 180°, so there is no need to report them.

It can be seen that the maximum voltage across these switches has reached an approximate value of 250 V, this value being given by the sum of the voltages of the two Vdc sources used. No voltage spikes related to switching transients that exceed the value of the sum of the input Vdc voltages were verified.

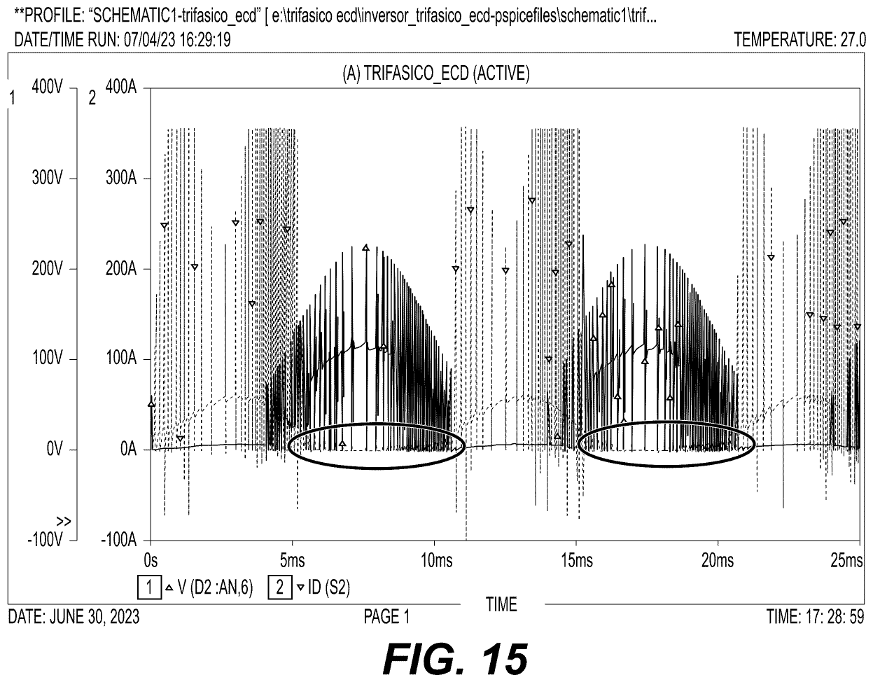

As seen in FIG. 15, the current and voltage in switch S2 are being highlighted by the ZCS (Zero Current Switching) switching in the negative half cycle of the output voltage generation.

ZCS switching occurs in similarly in switches S6 and S10. In switches (S3), (S7) and (S11) ZCS switching is also present, following the same reasoning, however, being verified when the positive half-cycle of the output voltage is generated.

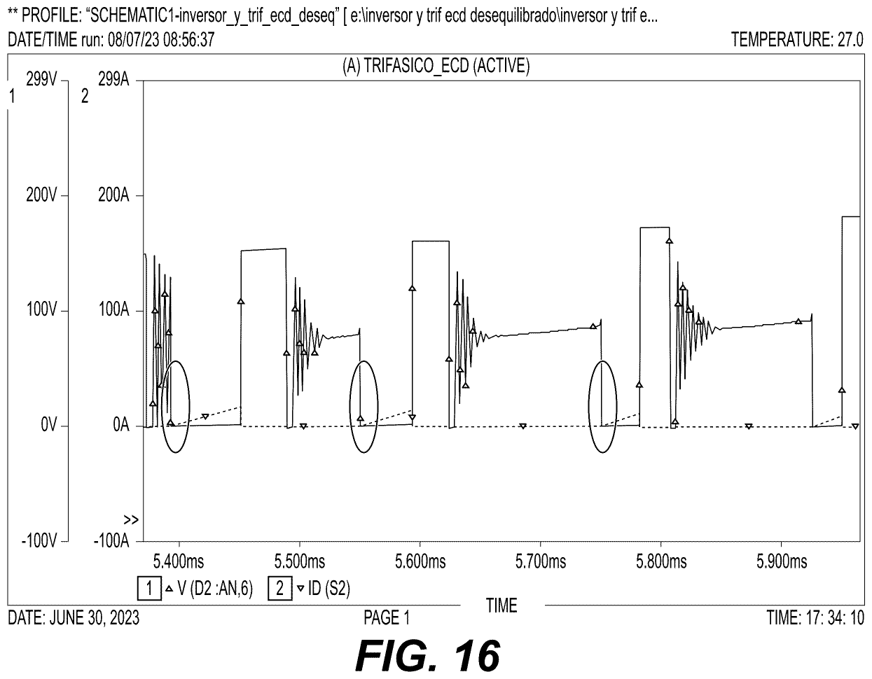

The recited switches feature non-dissipative ZCS switching only at the conduction input. Moreover, in FIG. 16 the entry into conduction in the ZCS soft mode can be seen highlighted by the ellipses.

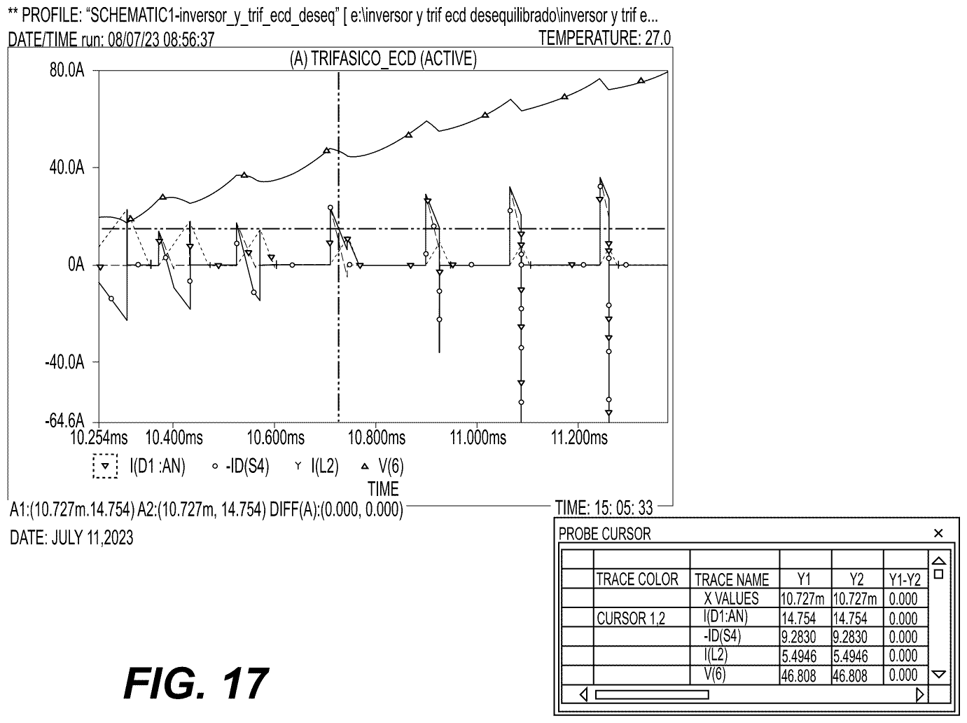

As seen in FIG. 17, the output voltage in the inverter increases in the positive half-cycle of its formation, with the stages of rising (capacitor charging (C1)) and falling (capacitor discharging (C1)) of the voltage (V(6)) being clearly verified.

The currents in inductor L2 (IL2), in the intrinsic switch diode (S4) (represented by -ID((S4))) and in diode D1 (I(D1: AN)) are also visualized. They occur during the capacitor discharge periods (C1), as can be seen in FIG. 17. Highlighted by the intersection of the dotted lines is a snapshot of the balance of these currents.

It can be seen that the current in the switch (S3) (IL2=5.49A) is given by the difference between the current that flows through diode D1 (I(D1: NA)=14.75A) and the current that flows through the switch body diode (S4) (−ID((S4))=9.28A). As the current in D1 decreases linearly (L1 discharge current), the current in the switch (S3) (IL2), due to the presence of the inductor L2, increases linearly, providing ZCS switching at the conduction input of this switch.

At any captured instant, this current balance dynamics is seen, allowing switches (S3), (S7) and (S11) to enter conduction in ZCS mode during periods of positive formation of the inverter output signal and switches S2, S6 and S10 to enter conduction in ZCS mode during periods of negative formation of the ECD inverter output signal.

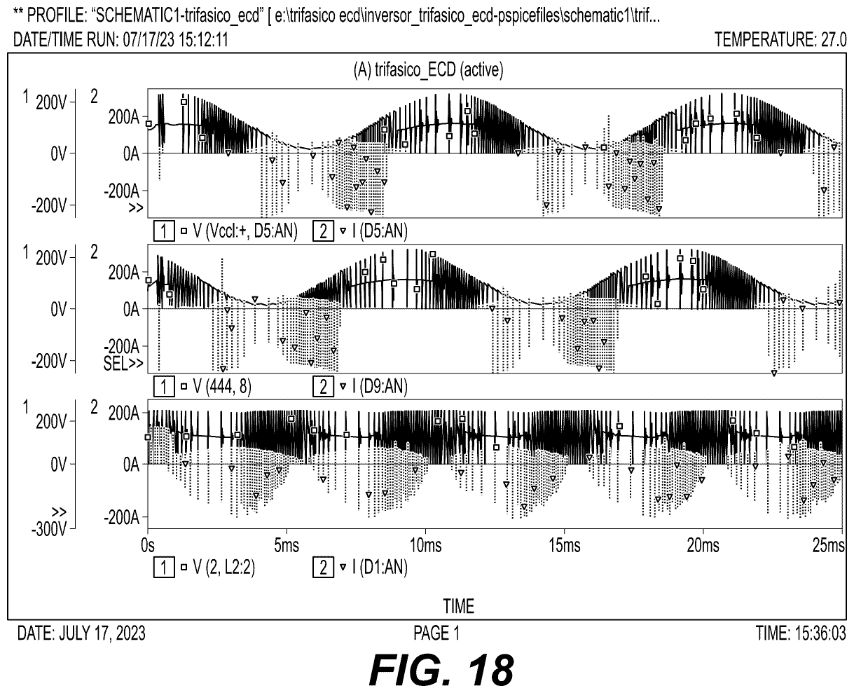

Proceeding to FIG. 18, the voltage and current waveforms in diodes D1, D5 and D9 taken here as examples are seen. The voltages in the other diodes are similar to their counterparts in other arms, only being shifted in time in relation to those seen in this figure. It can be seen that the voltages across these blocking diodes are equivalent to the sum of the voltages from the two sources.

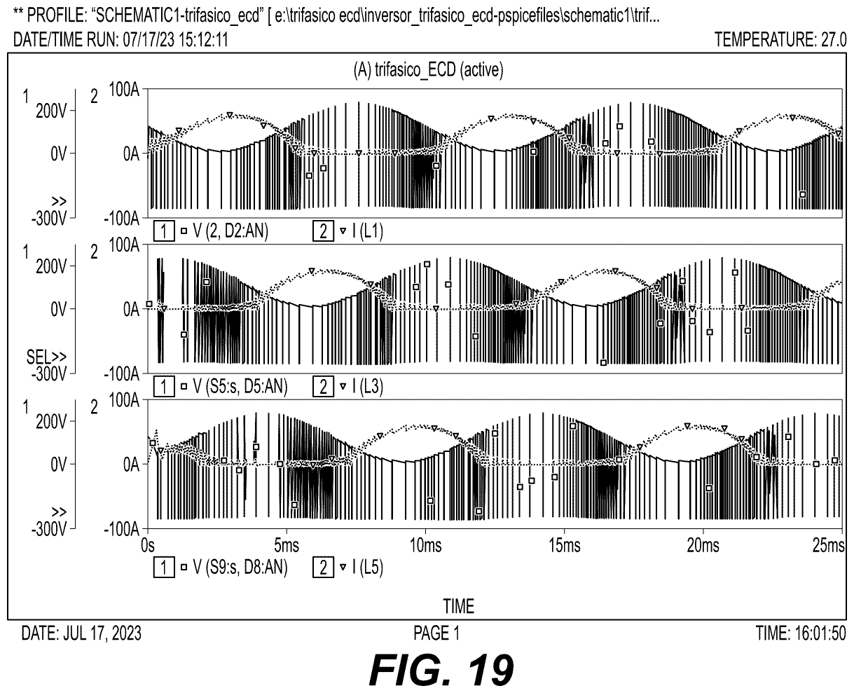

As observed in the simulations performed, voltages in all semiconductors present in this new inverter are given by the sum of the voltages of the Vdc sources, therefore, it is necessary to pay attention when choosing these electronic components. Furthermore, FIG. 19 shows the voltages and currents of inductors L1, L3 and L5. The voltages and currents in inductors L2, L4 and L6 are similar to their respective ones above, only displaced by 180° from those seen in FIG. 19.

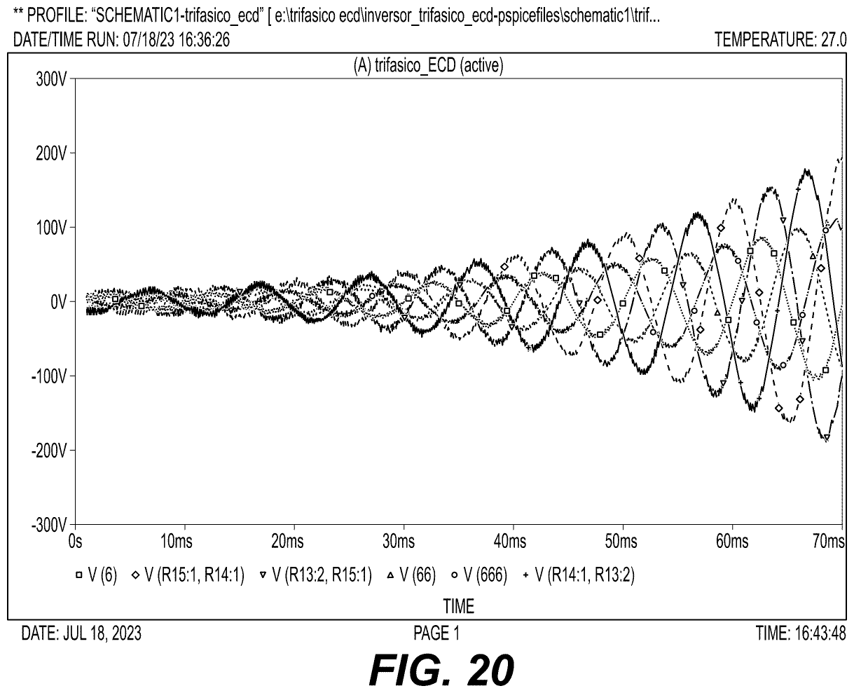

Furthermore, the graph in FIG. 20 was obtained by enabling the parameter dumping factor-DF to be obtained the Reference1, Reference2 and Reference3 sources and adjusting its value to −40. With this parameter enabled, the indicated voltages begin to increase their amplitude value following an exponential time response equation. It can be noted that the line and phase voltages at the inverter output increase in amplitude, thus following this exponential trend. Frequency is kept fixed, with the value of 100 Hz being used.

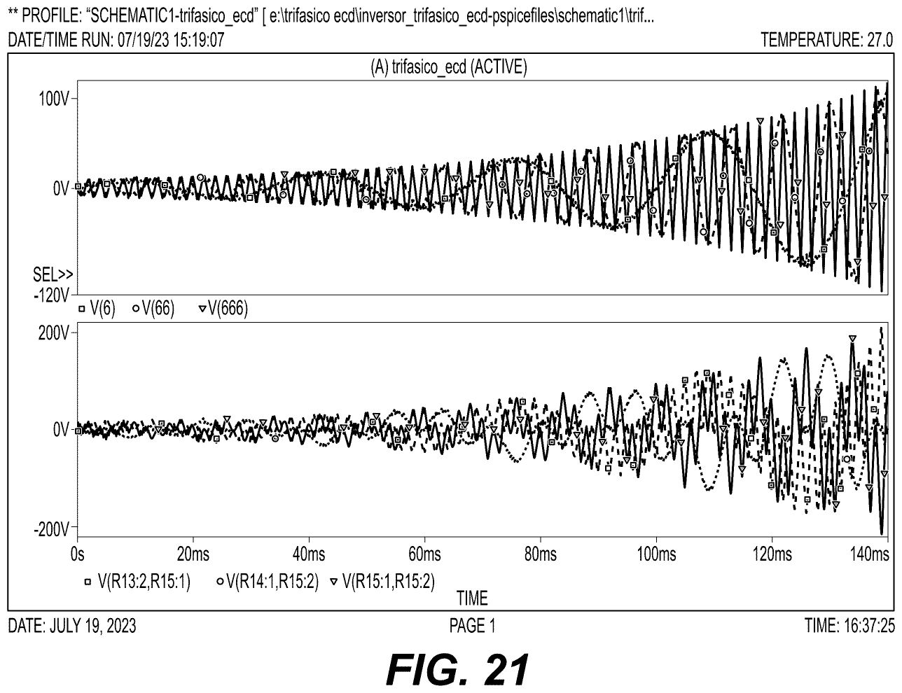

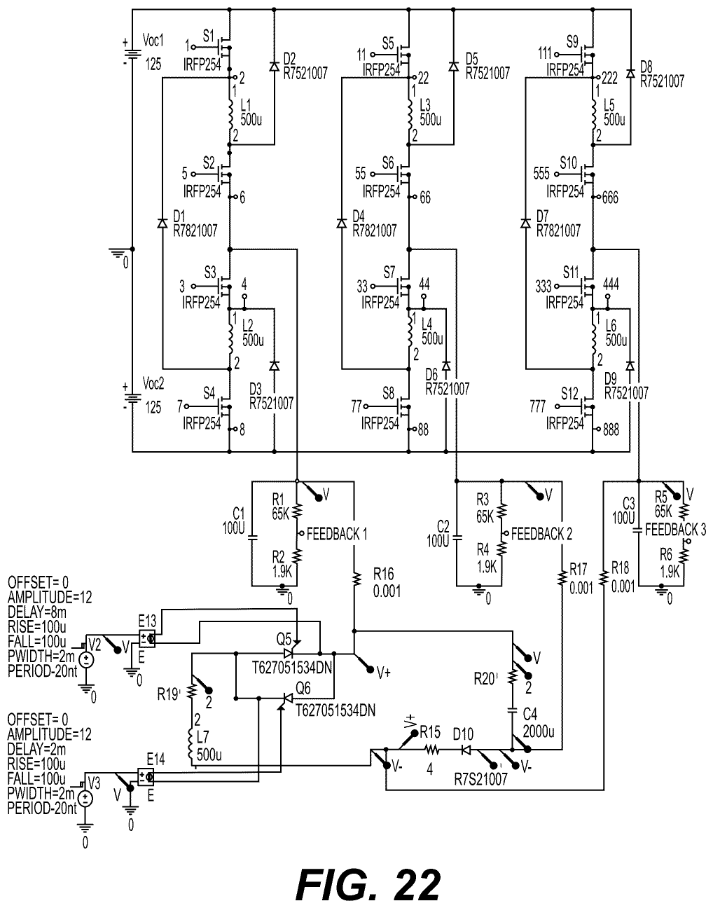

Changing the frequencies by using the amount of 30 Hz for Reference1 voltage, 120 Hz for Reference2 and 500 Hz for Reference3 and a dumping factor-DF equal to −20 applied to these signals, the voltage delivery capacity at different frequencies that the Three-Phase ECD Inverter has, presenting excellent response throughout the indicated range, as can be seen in FIG. 21.

In both simulations using the dumping factor the same 50 triangle connected load was used in series with a 3 mH inductor in each phase.

Since different frequencies were used in the reference voltages and since line voltages are a vectorial composition of phase voltages, the waveforms of these line voltages acquired the shapes seen in the lower part of FIG. 21.

A more complex test using an unbalanced triangle connected load was subsequently proposed. A circuit composed of a half-wave rectifier, represented by a diode in series with a 4Ω resistor, was inserted into one of the outputs. Δt the other end, two thyristors were used in antiparallel, supplying a load. RL composed of a 2Ω resistor in series with a 500 pH inductor. The trigger times were chosen randomly in order to generate a non-linear current, being adjusted to 2 ms (α=) 72° and 8 ms (α=288°) and a period of 20 ms was set for these trigger signals.

Finally, a 2000 μF capacitor was used in series with a 2Ω resistor, closing the proposed triangle connection. Frequencies of the reference signals were kept fixed at 100 Hz. The damping factor was enabled once again in the three reference sources, with its adjusted value in DF=−20.

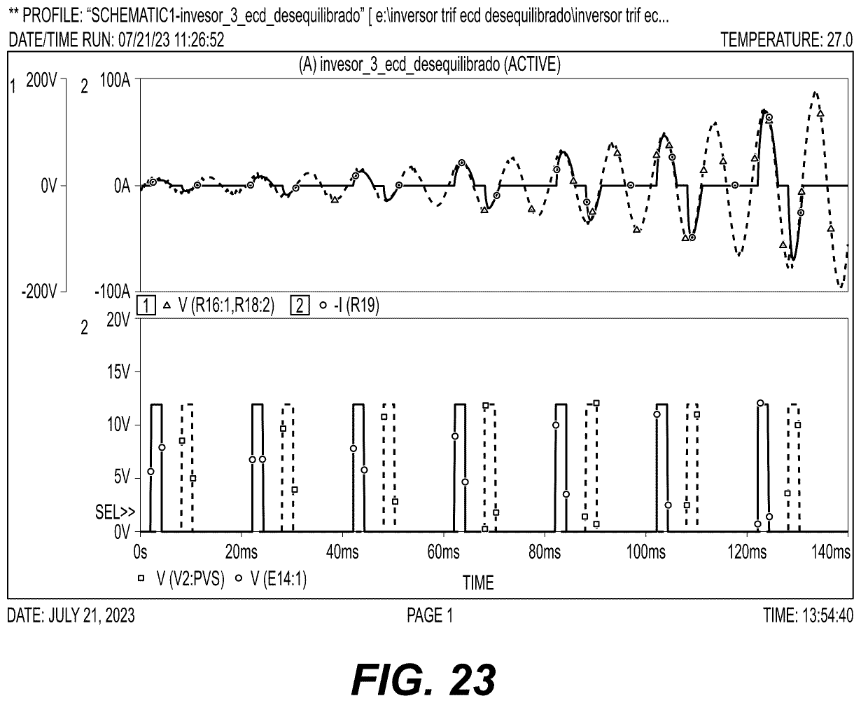

As seen in FIG. 23, there is a line voltage where the thyristors are connected as well as the non-linear current that flows through the RL load connected to this branch. The trigger pulses of these thyristors are also shown at the bottom of the same figure.

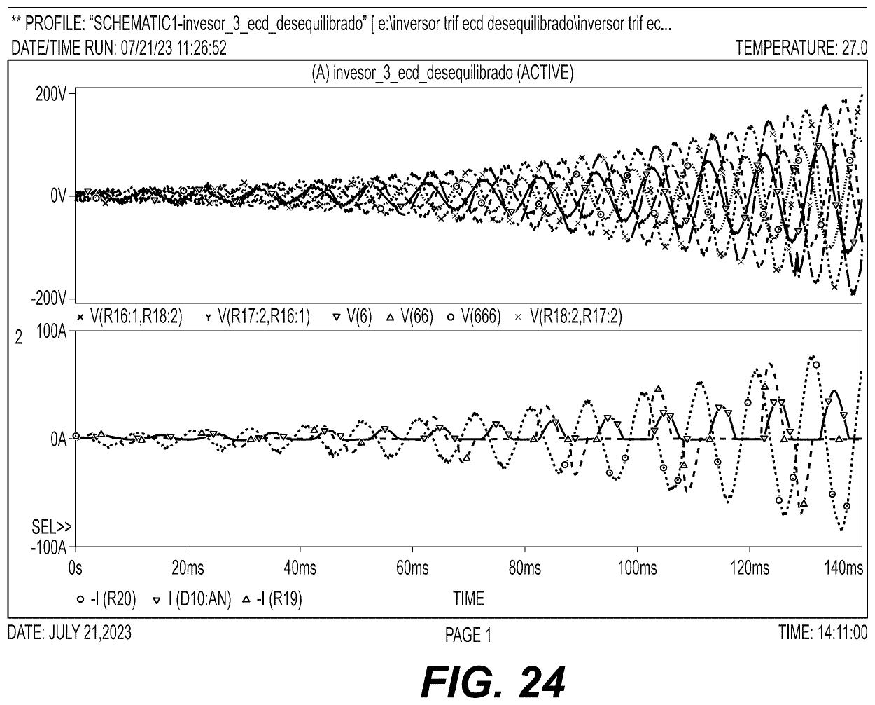

In the upper part of FIG. 24, the line and phase voltages at the output of the claimed inverter can be seen, and in the lower part, the phase currents in the described loads. Circulating unbalanced currents do not at any time harm the generation of the new inverter output sinusoidal voltages, which remain stable and without overshoots apparent.

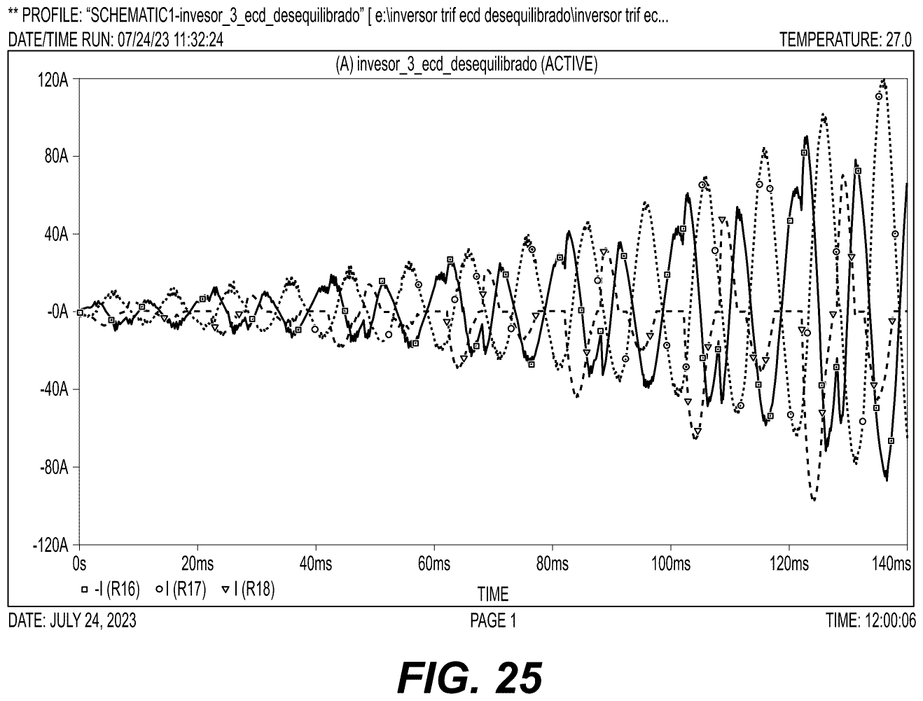

Furthermore, circulating line currents can be seen in FIG. 25. Composition of the currents from the half-wave rectifier, the RL load fed by the thyristors and the RC load results in distorted, non-linear currents with DC content, as can be seen.

Even at low amplitudes and with non-linear loads, the inverter remains faithful in generating sinusoidal output signals. No overshoots or distortions are seen in the generated output voltages, nor high sags.

The design based on three energy storage elements per phase, represented by two inductors and one capacitor, as well as the mechanism for controlling and discharging currents by the diodes of the designed cell, brings robustness and efficiency to the general operation of the new proposed inverter.

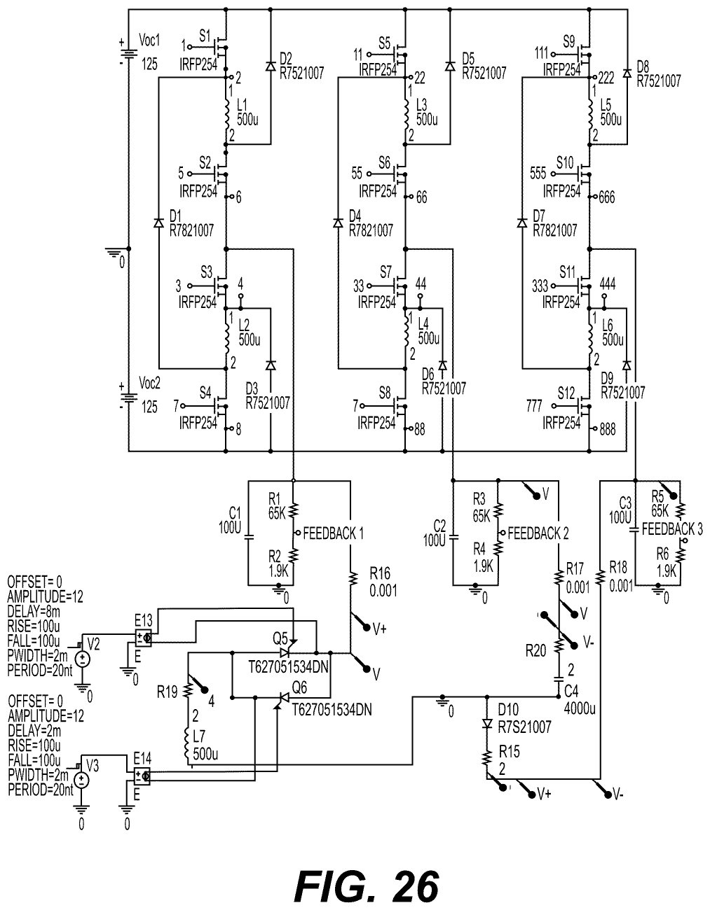

In order to verify the response and operation of the new ECD Three-Phase Inverter in a grounded star configuration, new simulations were carried out. The load used was similar to that used in the triangle simulations, however, some changes were made, such as changing the resistance value in the half-wave rectifier from 4Ω to 2Ω, changing the value of the RC load capacitor which was changed to 4000 μF and finally, changing the value of the load fed by the thyristors, changing the resistor value to 40. The damping factor was kept at DF=−20, as seen in FIG. 26, the simulated circuit.

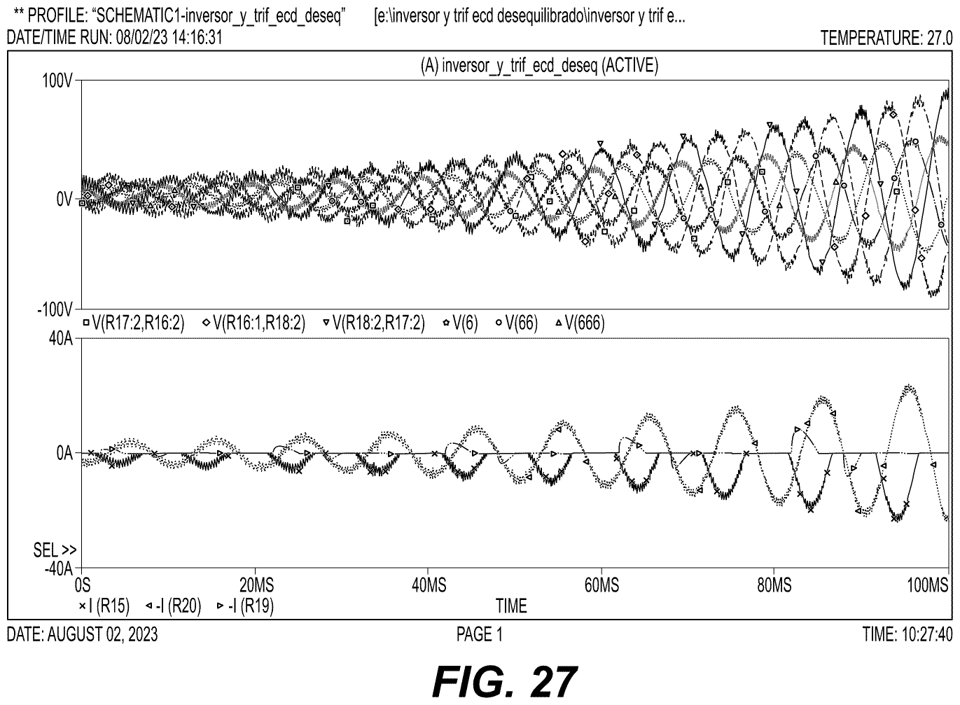

In the upper part of FIG. 27, the line and phase voltages can be seen at the output of the new three-phase inverter with a star-connected load and grounded neutral. In the lower part of the same figure, the line currents can be seen, which are identical to the phase currents, given the star closure used.

An unbalanced load is not an obstacle to the operation and perfect functioning of the control and inverter as a whole. There were no changes in the voltages generated, which remained stable, with low THD and with no apparent overshoots.

The fact that unbalanced and non-linear loads were connected did not cause quality issues in the voltages generated by the inverter, nor did it cause atypical harmonic distortions in the output voltages, even when changing the type of load connection.

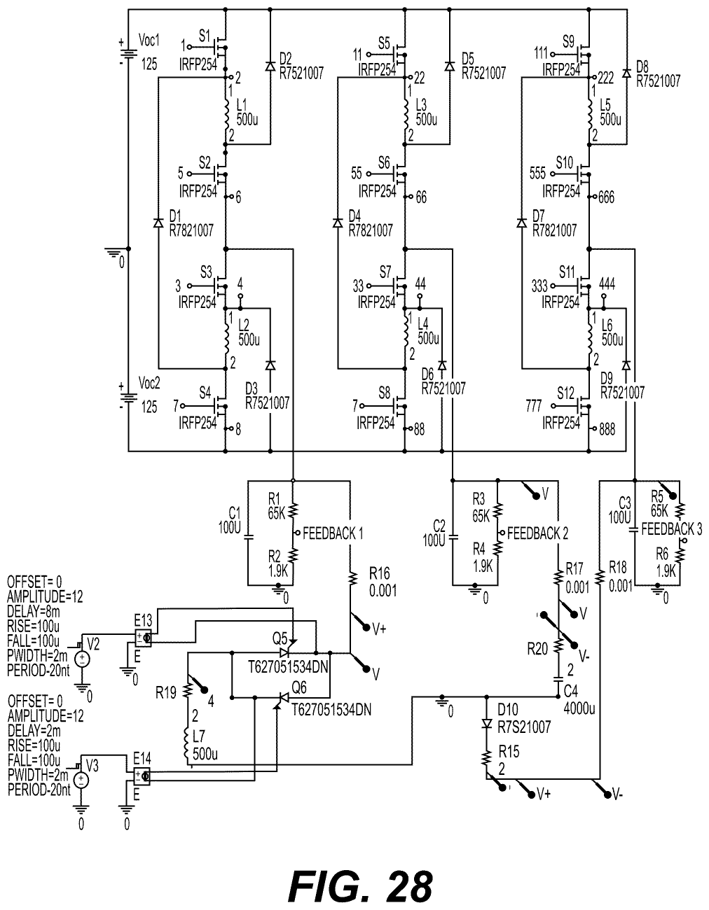

Again, new simulations were carried out, this time with a view to verifying the response and operation of the new three-phase inverter in a star loaded configuration with an isolated neutral. The load used was the same as that used in the star simulations with grounded neutral, as seen in FIG. 28.

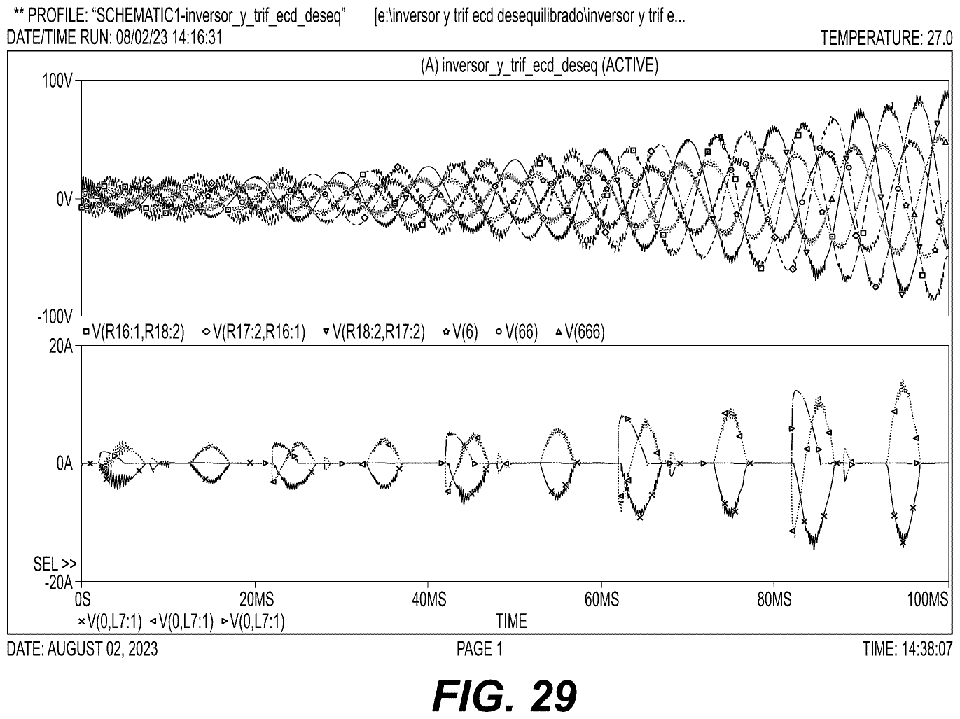

FIG. 29 shows the line and phase voltages at the output of the new inverter with a star-connected load with isolated neutral. No distortions or even changes in the shape of the sinusoids nor other factors were found to disrupt control operation and consequently the generation of the output voltages.

In the lower part of the same figure, the line currents can also be seen, which are identical to the phase currents, given the star closure used. However, the currents were found to have undergone changes in their shapes, no longer resembling those found in star connection with grounded neutral.

The current that circulates through the RC circuit (—I(R20)) is no longer similar to the current in FIG. 27, now presenting itself as a waveform that is no longer sinusoidal and linear. Even being an RC load and even if the claimed three-phase inverter generates sinusoidal line and phase voltages, there is no longer the circulation of a sinusoidal current ahead of the voltage, as should be the case in RC circuits fed with sinusoidal waves.

The same is valid for the current circulating through the thyristors and feeding the load RL, which changed. In the branch where the resistance and the diode are located, the current waveform as well as the variation of the modules over time were also found to have changed.

Since the currents do not return to earth in this type of connection and are necessarily added up to the load's neutral, they acquire different forms from the usual ones, so that they cancel each other out at the neutral point.

For this to take place, the voltages between the load phases and neutral change, taking on shapes and modules that are quite different from the sinusoidal line and phase voltages, as seen in FIG. 31.

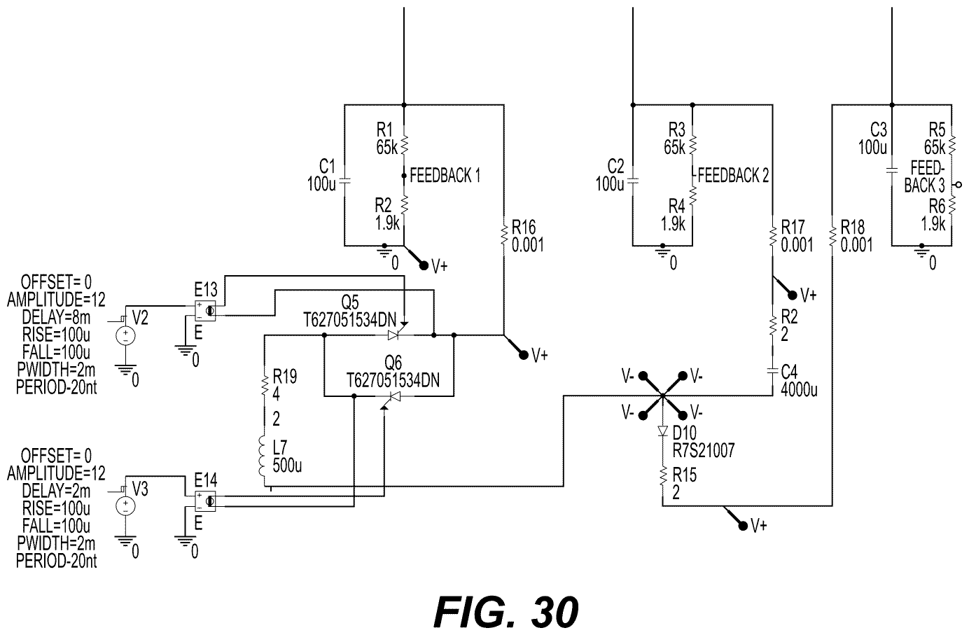

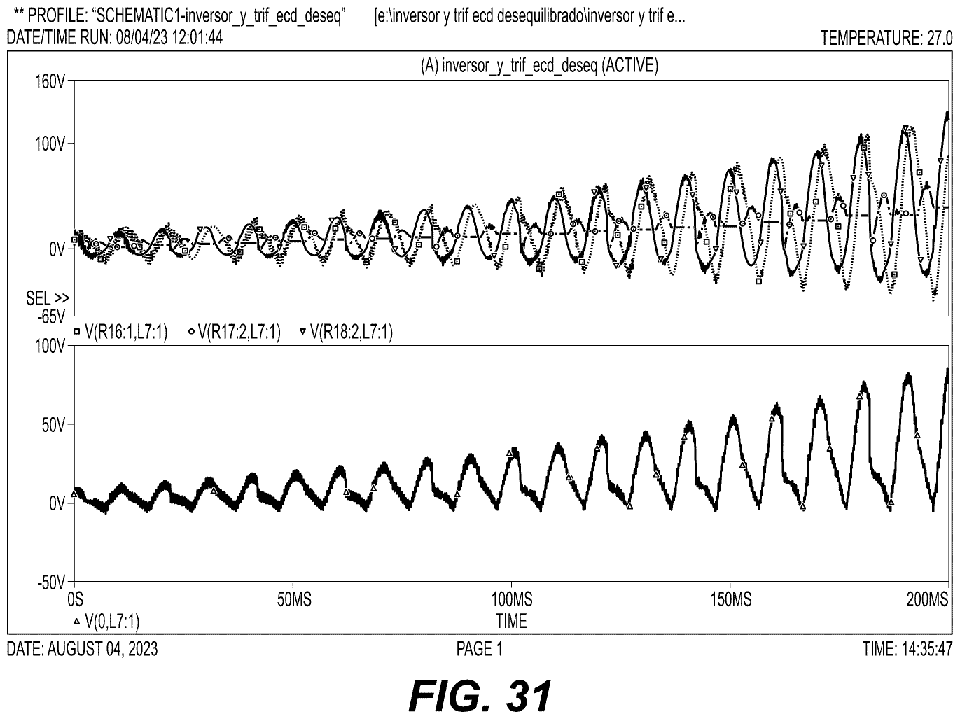

Furthermore, FIG. 30 shows the points where the leads were connected to measure these voltages, which for ease of reference will be designated as VAN′, VBN′ and VCN′ for those voltages measured between the inverter output terminals and the neutral point of the star load, and VN′0 (V(0,L7:1) for the voltage measured between the neutral point and the ground.

Non-sinusoidal behavior is observed, as well as a high DC level that shifts the waveforms, with the voltages VAN′, VBN′ and VCN′ undergoing changes in module and shape depending on the imbalance imposed by the loads, reflecting in the currents that not having a ground point to flow add up at point N′ and cancel each other out.

Another fact to be observed was the appearance of a voltage measured between the ground and the center of the star, which is designated herein as VN′0 as also seen in FIG. 31.

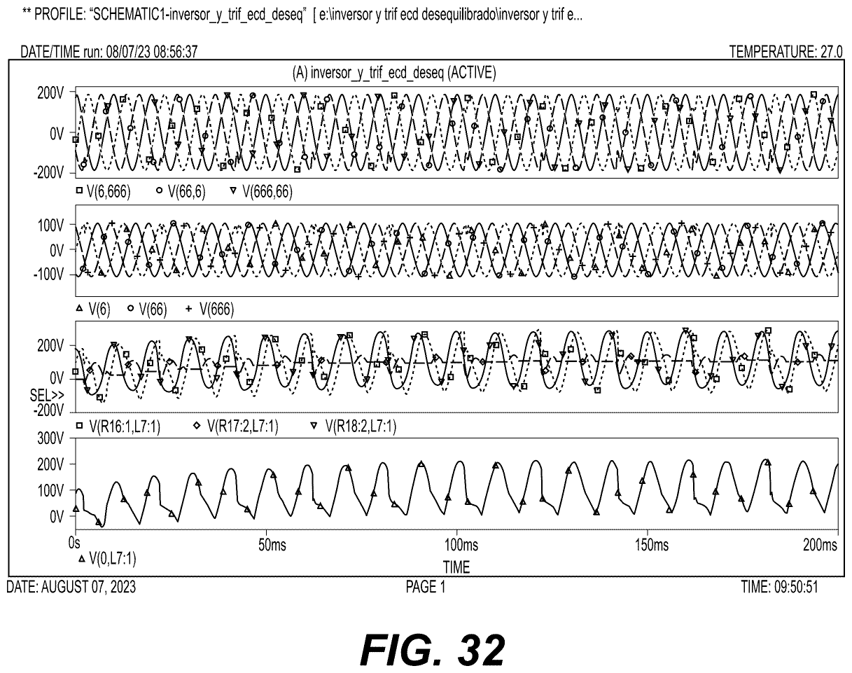

As seen in FIG. 32, in steady state and without using the damping factor in the reference voltages, the waveforms of the line voltages are seen at the top and in sequence with the phase voltages, where it can be noted that all of these remain sinusoidal with no distortion, presenting only small dips resulting from the insertion of the load controlled by the thyristors.

Still in the same figure, the waveforms VAN′, VBN′ and VCN′ are also observed, ending with VN′0. As previously shown, there is a high level of harmonic distortion in these voltages, especially in the VBN′ voltage (V(R17:2, L7:1), with a high DC level being responsible for their displacement on the x axis.

However, as seen in the line and phase voltages, this fact does not affect the operation of the proposed inverter, which still generates these sinusoidal voltages even with unbalanced loads and in star connection with an isolated neutral.

All of these waveforms were plotted with the reference voltages set to 3 vca peak, with a gain of 35.2 being applied to these signals.

In addition, four yield graphs were plotted. In the first of them, the yield value was obtained with the claimed three-phase inverter operating at a symmetrical 125 Vdc input voltage, amplitude of the reference sinusoidal signals adjusted to 3 Vac peak, 1000 and 20kΩ resistors in the hysteresis comparators and a gain of about 35.2 times.

In this configuration, a phase-to-ground output voltage with a peak value of 105.6 Vac is provided, applied to the same unbalanced, non-linear, star connected load with isolated neutral as in the previous section.

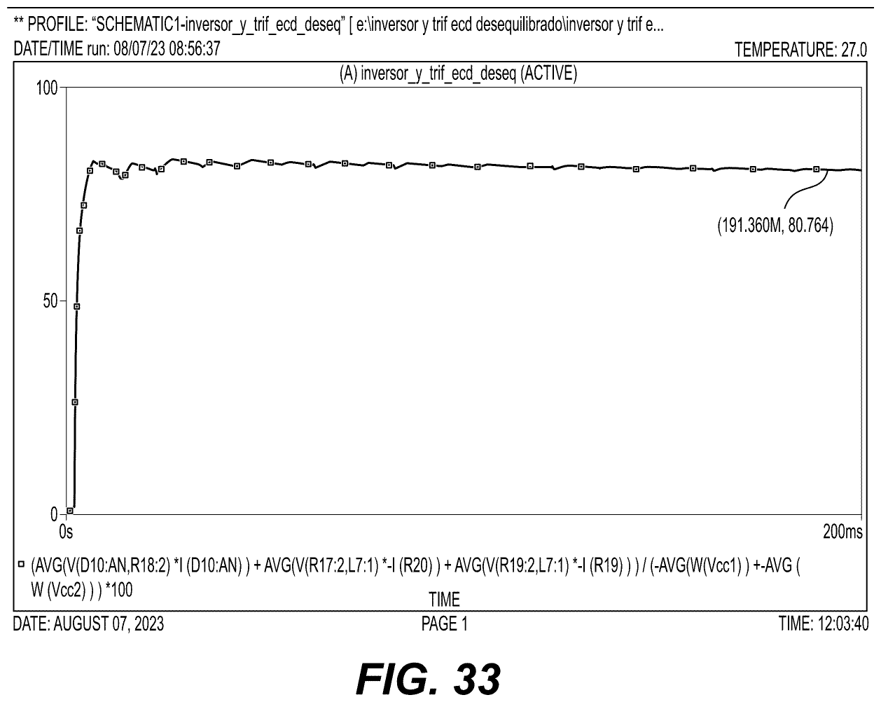

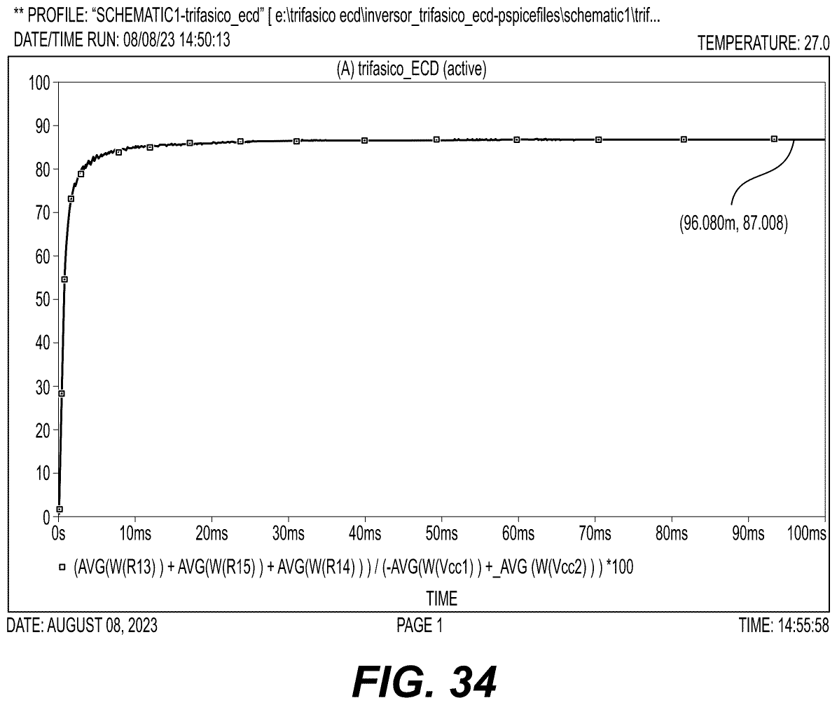

Therefore, the 2Ω RC load and 4,000 μF capacitor, the 4Ω RL load and 500 pH inductor controlled by two anti-parallel thyristors and the half-wave rectifier with a 2Ω resistive load were used. The frequency used was 100 Hz. Even when dealing with an unbalanced, non-linear load with reactive elements, a 80.7% yield was achieved, as seen in FIG. 33.

The next simulation described was performed with a purely resistive 6 Ωtriangle connected load, with the claimed three-phase inverter operating with a symmetrical 125 Vdc input voltage and an amplitude of the reference sinusoidal signals adjusted to a 3 Vac peak.

There was a change in the 100Ω resistors of the comparators, which are now adjusted to 170Ω. The 20kΩ resistors were kept unchanged. The gain has been slightly changed to approximately 37.1 times.

An overall yield of 87% was achieved for the configuration described above. Attention should be paid to the voltage level used, which is considered low for such power volumes, corroborating the loss of efficiency. As semiconductor elements with outdated technology were used, values greater than 90% were not possible to be achieved. The fast recovery MOSFETs and diodes that were used are obsolete and inefficient compared to modern semiconductors made from Silicon Carbide or Gallium Nitride.

In the simulation described below, the same previous configuration was used, using the same values of electronic components and the triangle connection with a resistive load of 6Ω. However, now three distinct reference signs have been used at the non-inverting input of the comparators, which are placed in a staggered manner, with frequencies set at 20 Hz, 200 Hz and 1 kHz.

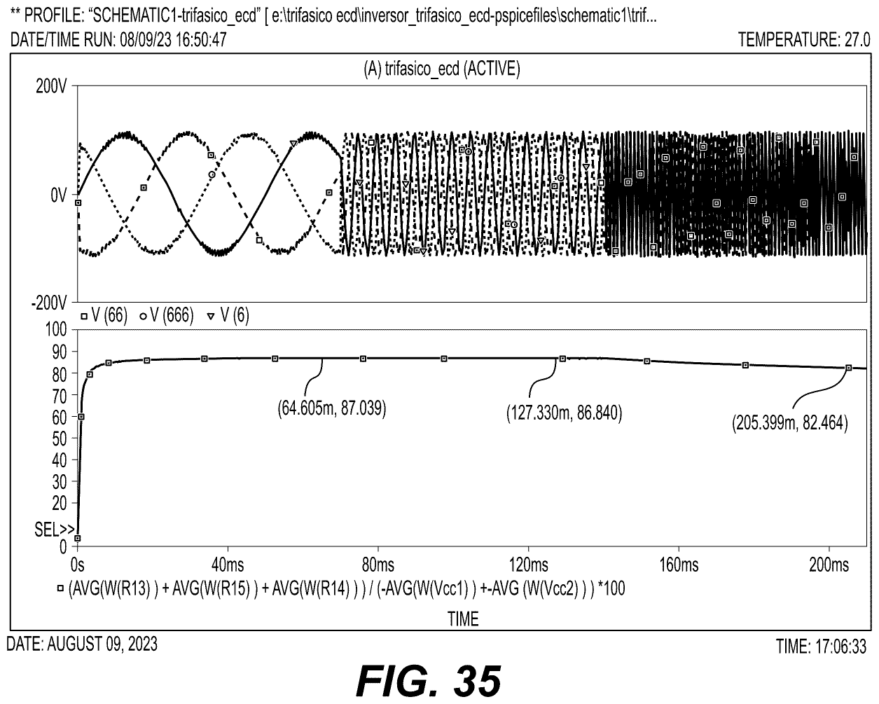

The purpose of this test was to assess the yield of the three-phase inverter at different and spaced frequencies. As seen in FIG. 35 where the output voltages are shown at the top and the yield plot at the bottom.

For a 20 Hz frequency a 87% yield was achieved, for the 200 Hz frequency 86.8%, and for the 1 KHz frequency a yield of 82.4% was obtained. Finally, for the last simulation, the same parameters as used in the previous simulation were used, only changing the load connection to Y with grounded neutral, however, 3Ω resistors were used per phase.

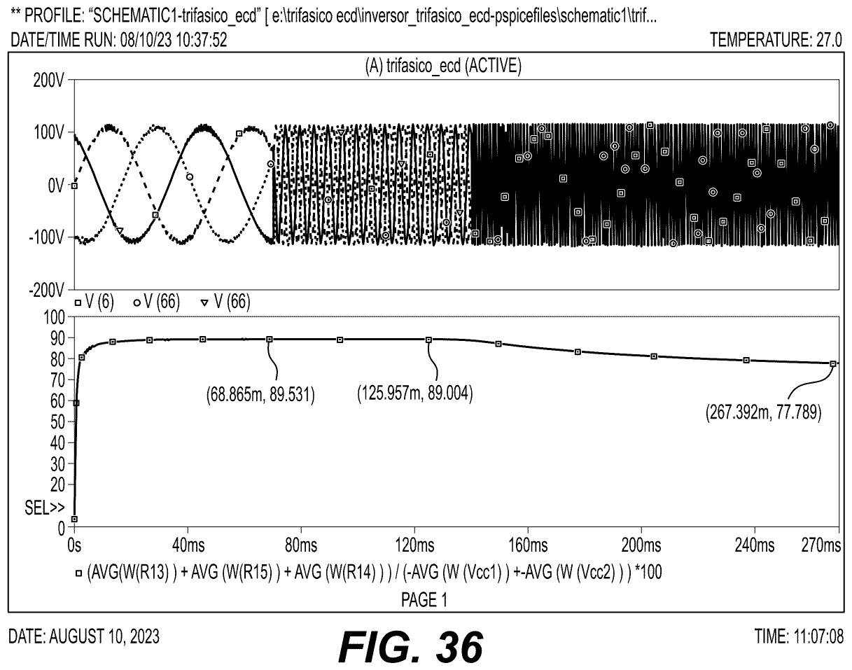

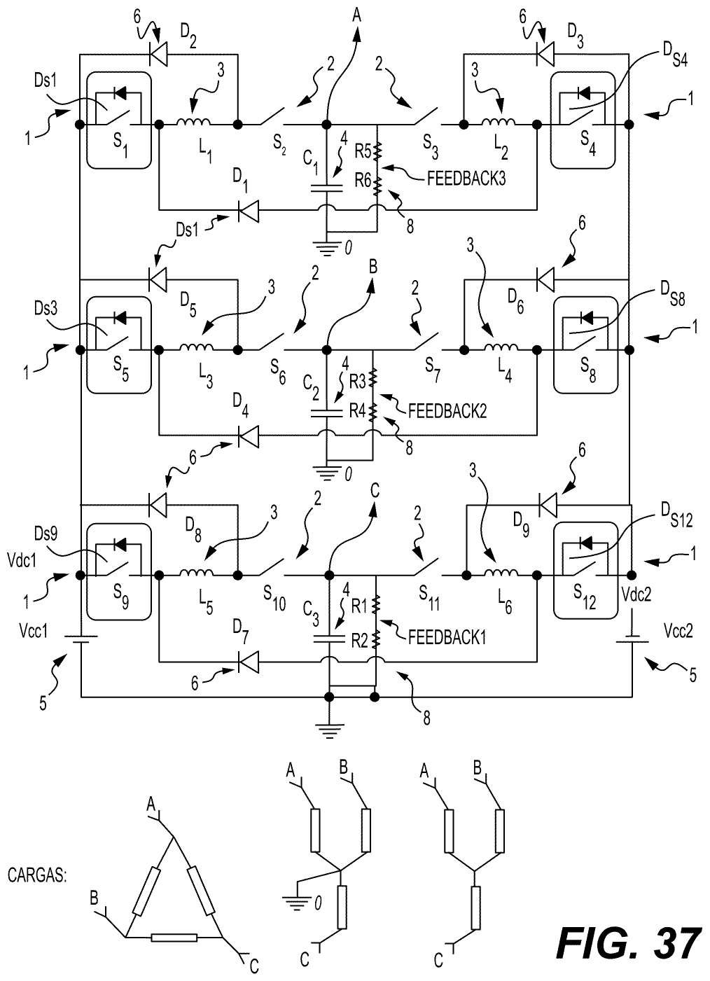

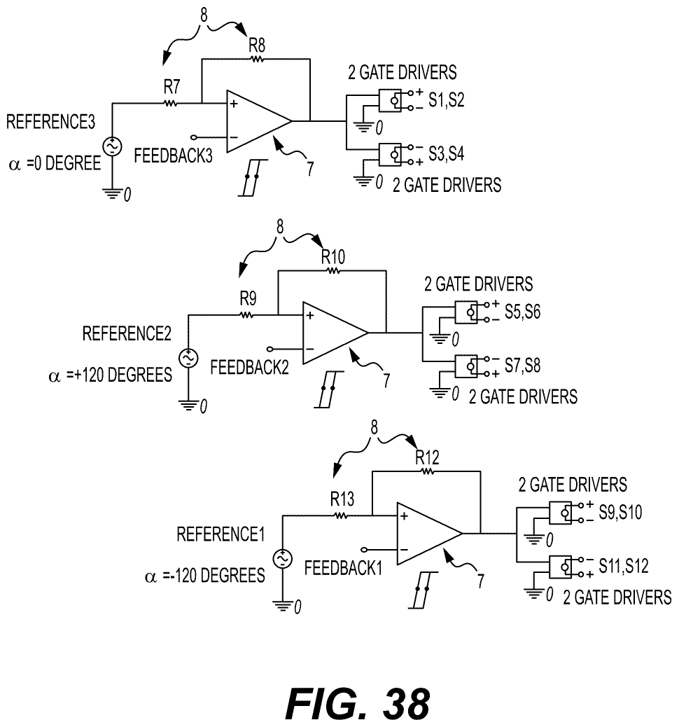

In FIG. 36, the output voltages are seen at the top and the yield graph at the bottom. Δt a frequency of 20 Hz, the yield reached an approximate value of 89.5%, at a frequency of 200 Hz the yield was 89%, and at 1 KHz, the yield was 77.7%. The level of harmonic distortion for the frequency of 1 kHz increased significantly, interfering and penalizing the yield in this load and frequency condition.

It can be noted that in the grounded Y connection load, the yield for the lowest frequencies was higher than in the triangle connection, reaching values close to 90% efficiency.

One possible reason for the reduction in efficiency in the triangle configuration compared to the star connection may be associated with the higher power that was drained by the load in this simulation, increasing joulic losses in the semiconductors.

Efficiency of this inverter must inevitably rise to much higher levels by using modern semiconductor devices, such as those made of silicon carbide or gallium nitride, using annealed magnetic material from nanocrystalline cobalt deformation in the inductors, as well as using voltage ranges more suitable for the required output powers.

Associated with the changes proposed above and making adjustments to the hysteresis system, as well as improving inductor and capacitor values, we can further increase the yield to other efficiency levels, with values greater than 95% at nominal load being targeted.

An important point concerns operation at higher frequencies that are possible to be used with the new proposed three-phase inverter. The possibility of delivering high power at frequencies where the induction motor operates in field weakening is available in this new inverter, extending the operating range, which is most often limited to 120 Hz by the passband of the output filter of conventional inverters.

Since the proposed inverter has no output filters, it is possible to use it in various configurations and applications, covering a wider range of output frequencies as well as being usable with non-sinusoidal input voltages in the references.

The total harmonic distortion (THD) rate obtained in simulation for the output voltage of the claimed three-phase inverter was 3.9%, for the operating frequency set at 20 Hz, with a grounded star load of 30 per phase, using up to the 50th harmonic.

For the triangle connected load with 6 Ωper phase and a frequency of 200 Hz, the THD obtained was 4.3%. The THDs were obtained with the inverter operating with a symmetrical 125 Vdc input voltage, a reference signal amplitude of 3 Vac and a gain of approximately 37.1 times, providing a phase-to-ground output voltage with a peak value of 105.6 Vac.

THD was also simulated with the star connected, isolated, non-linear and unbalanced load, using loads at a frequency of 100 Hz. The THD obtained under these circumstances was 2.9%. This peculiar fact is yet another indication of operation under various scenarios and arrangements of loads and frequencies, still ensuring excellent operation and operation with low THD.

As with its predecessor, it is possible to find optimal values between yield and THD by changing the values of the feedback loop, as well as the reference voltages used, adjusting the values of the inductors and capacitors and still obtaining large output powers.

The values obtained in simulation demonstrate that the claimed three-phase inverter can reproduce sinusoidal voltage signals with low harmonic distortion.

That being said, the theoretical basis and the simulations carried out have shown that the new inverter of the present invention, designated herein as the three-phase ECD inverter has a sinusoidal output voltage with no overshoot, non-dissipative switching in half of the switching cycles and capacity to supply large three-phase loads.

Other positive points that can be concluded from the theoretical study and simulations are the operation without a passive output filter with the ability to generate both sinusoidal and non-sinusoidal voltages in varied power and frequency ranges. As it has a voltage follower characteristic, it replicates the voltages that are sent to the hysteresis control inputs to its outputs, instead of generating square voltage pulses that are typical of commercial inverter topologies.

The three-phase ECD inverter of the present invention has only two operating stages. In its operation, non-dissipative ZVS and ZCS switching is verified in the semiconductor switches in certain closing and opening cycles, increasing the energy efficiency of this inverter, in addition to reducing the emission of radiated and conducted electromagnetic interference.

It can be concluded that the claimed three-phase inverter can deliver variable sinusoidal voltage at its output, without a passive filter and being able to work with satisfactory and commercially applicable electrical yield.

In other words, it contributes with the characteristics of (i) not generating degradation of the isolation and burning of the windings due to overvoltages caused by reflections of the output square waves of conventional inverters; (ii) it mitigates premature failures in motor bearings compared to those caused by harmonics generated by conventional inverters; (iii) it reduces excessive vibrations and temperature increases and losses due to harmonics, without compromising the electrical yield of the TIM; (iv) it mitigates acoustic noise; (v) it eliminates the need for application of derating of power in the TIM or purchase of special motors; (vi) it reduces radiated and conducted noise-EMI mainly in the feeders (cables) that supply the motors; and (vii) it allows the parallel connection of more than one inverter, among other benefits.

In the simulations carried out, operation of the claimed inverter was verified when supplying balanced linear loads, as well as non-linear and unbalanced loads. Simulations were performed with the star connected load with grounded neutral, star connected load with isolated neutral and delta connected load. In all tests, the inverter operation was verified without compromising control or marked distortion of the waveforms generated at the output. Loads with different inductance, capacitance and resistance values were used, associated with thyristors and rectifier diodes, generating non-linear and distorted current patterns and even so the new inverter was able to maintain its control and sinusoidal output, presenting satisfactory and improved operation.

The claimed three-phase inverter exhibited ease of operation in its control, not requiring dead time circuits that are very common in full-bridge topologies where they are necessary so that there is no short circuit in the arms. Output voltage control is performed in a closed loop by complementary pulses generated by the control circuit, which in turn is simply made up of voltage comparators.

Furthermore, tests and trials on future prototypes will make it possible to assess improved operations and higher yield efficiency in the operation in scalar control mode of driving the TIM of the claimed inverter. In addition to also using the voltage follower benefit of this new inverter, it is possible to apply signals to the references that can control the motors in a way similar to vector control, among other possibilities.

1. A three-phase inverter, comprising:
six two-way semiconductor switches;
six one-way current switches;
six inductors;
nine diodes;
three depolarized capacitors;
six feedback resistors; and
two symmetrical direct voltage sources in their main power structure,
wherein a sinusoidal output voltage with low harmonic distortion is produced.

2. The three-phase inverter according to claim 1, wherein alternatively twelve two-way current switches are used instead of six one-way and six two-way switches.

3. The three-phase inverter according to claim 1, wherein when generating PWM signals, the aforementioned six resistors and three voltage comparators configured in hysteresis are used, as well as said symmetrical 15 Vdc sources.

4. The three-phase inverter according to claim 1, wherein said two-way switches are used to conduct currents that flow in the opposite direction, ensuring the flow of charge to two direct voltage sources Vdc1 and Vdc2.

5. The three-phase inverter according to claim 4, wherein the diodes present in all the switches associated with the diodes existing in an inverter cell regenerate or dissipate energy through a braking resistor assembly.

6. The three-phase inverter according to claim 5, further comprising two stages of operation taking place simultaneously in each arm, wherein the first stage comprises Δt1 [t1−t0];
and the second step comprises Δt2[t2−t1].

7. The three-phase inverter according to claim 6, wherein in the first stage, the switches close, with the closing of each pair being 120 electrical degrees phase shifted relative to each other, the voltages on the output capacitors begin to grow linearly and the energy stored in the inductors, in association with the input voltage source supplies energy to them and to the load.

8. The three-phase inverter according to claim 7, wherein the energy stored in the inductors is discharged through the power sources, through the diodes, antiparallel to the switch, which are directly polarized, being analogous in said diodes which are directly polarized, thus allowing demagnetization of the inductors.

9. The three-phase inverter according to claim 8, wherein the closing of the switches takes place first, after 120° electrical degrees the switches close, and after 240° (or −) 120° the switches close, wherein these shifts are inserted into the reference signals, which must be 120° phase shifted relative to each other.

10. The three-phase inverter according to claim 9, wherein part of the energy stored in the inductors and which is discharged, contributes to the capacitor discharge, also, the association with inductors and the voltage source further provides energy for discharging the capacitors and the connected load.

11. The three-phase inverter according to claim 10, wherein the switch conducts part of the demagnetization current that flows through the body diode of this switch, resulting in non-dissipative switching both when opening and closing, wherein the other part of such demagnetization current flows through the inductor and through the switch, which causes this switch to enter non-dissipative switching in a ZCS mode.

12. The three-phase inverter according to claim 11, wherein in each arm, part of the demagnetization current is reused in the linear load of its respective output capacitor, and the other part of this current returns to the sources.

13. The three-phase inverter according to claim 12, wherein in periods of negative half-cycles of the generated sinusoids, the switches operate in non-dissipative ZVS switching both at the conduction input and at the conduction output.

14. The three-phase inverter according to claim 13, wherein the switches operate in non-dissipative ZVS switching when opening and closing in all positive periods of generation of the output sinusoids.

15. The three-phase inverter according to claim 14, wherein in ZCS switching, the conduction input in switches takes place in the negative half-cycle of generation of the inverter output voltages, and in switches it takes place when the output voltages are generated in the positive half-cycles, with the switches presenting non-dissipative ZCS switching only in the conduction input.

16. The three-phase inverter according to claim 1, further comprising the control of all semiconductor switches using three hysteresis comparators, each one producing PWM signals to drive the four switches on each arm.

17. The three-phase inverter according to claim 16, wherein the three hysteresis comparators are applied using three reference sinusoidal signals 120° phase shifted relative to each other with low amplitude, which will be compared to the respective feedback signals sampled from the output terminals of each arm.

18. The three-phase inverter according to claim 17, wherein the comparisons generate PWM signals that activate the respective semiconductor switches, allowing the creation of three sinusoidal waves at their output terminals, with a module varying according to the change in the amplitude of these feedback signals or by changing the amplitudes of the reference sinusoidal signals.

19. The three-phase inverter according to claim 18, wherein sinusoidal signals 120° phase shifted relative to each other are connected to the non-inverting terminals of the respective comparators.

20. The three-phase inverter according to claim 19, further comprising a voltage-follower DC/AC inverter, wherein in the hysteresis control, the generated pulses control the power switches, causing the inverter output voltages to present the same waveforms as the reference signals, wherein a form of gain is generated by modifying the signal levels of Reference1, Reference2 and Reference3, wherein it is also possible to change the frequency of the output signal and the angular phase shift, and wherein the outputs of the comparators are connected to a gate driver for each switch.
